(19) United States
(12) Patent Application Publication
(10) Pub. No.: US 2009/0187484 A1
(43) Pub. Date: Jul. 23, 2009

(54) Soil treatments with carbon dioxide

(75) Inventors: Stephen Craig Arbogast, Port St. Lucie, FL (US); Ronald A. Becton, Ft. Pierce, FL (US); K. Bruce Jones, Marietta, GA (US); Herbert Nicholas Nigg, Lake Alfred, FL (US); Jane E. Reeb, Dunwoody, GA (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Cleareso, LLC

(21) Appl. No.: 12/218,165

(22) Filed: Jul. 11, 2008

Related U.S. Application Data
(60) Provisional application No. 61/022,308, filed on Jan. 18, 2008.

(51) Int. Cl. G06Q 30/00; A01N 59/04; A01P 7/04

(52) U.S. Cl. 705/14; 504/116.1

(57) ABSTRACT

A method is described for treating soil to increase plant growth or improve the health of plants, wherein a combination of carbon dioxide and a surfactant having pesticidal effects is applied. The invention also pertains to methods for applying bio-derived surfactants in combination with carbon dioxide to crops and other plants or to the soil used for such plants in order to reduce the need to apply environmentally unfriendly pesticides or fertilizers, as well as to improved methods of removing carbon dioxide from the atmosphere by applying the carbon dioxide to plants and soil in combination with surfactants, particularly bio-derived surfactants that can reduce the activity of certain pests in the soil.

This application claims the benefit of U.S. provisional patent application Ser. No. 61/022,308, filed Jan. 18, 2008, for soil treatments with carbon dioxide.

### BACKGROUND

1. Field of the Invention

This invention pertains to methods and compositions for treating soil to increase plant growth or improve the health of plants. The invention also pertains to methods for applying bio-derived surfactants in combination with carbon dioxide to crops and other plants or to the soil used for such plants in order to reduce the need for the application of environmentally unfriendly pesticides or fertilizers. The invention also pertains to improved methods of removing carbon dioxide from the atmosphere by applying carbon dioxide to plants and soil in the presence of surfactants.

2. Description of the Related Art

The release of large quantities of carbon dioxide into the atmosphere is a widely recognized environmental concern for which improved approaches are greatly needed. At the same time, carbon dioxide is a widely recognized nutrient essential for plant growth. While others have observed that carbon dioxide can be absorbed by the roots of many plants, relatively little attention has been given to the potential benefits of soil treatment with carbon dioxide and surfactants to potentially replace many pesticides while also enhancing plant growth and decreasing greenhouse gases in the atmosphere. Pesticide use, though necessary to maintain high yields for many crops, has also led to many environmental challenges. Without the use of pesticides and other means for treating agricultural pests, crop yields would be drastically lower, resulting in extreme shortages of many agricultural products. Even with modern pesticides, substantial crop losses occur due to a wide variety of pests. Agricultural pests such as arthropods (particularly insects), nematodes, weeds, and disease pathogens (viruses, bacteria, fungi, etc.) blemish, damage or destroy more than 30 percent of crops worldwide. Plant parasitic nematodes cause serious extensive damage to many agricultural crops. These generally microscopic worms feed mostly on the roots of host plants, but some species attack other parts such as stems, leaves and flowers. Almost all of the major plant species are susceptible to infection by species of nematodes. Arthropods such as root weevils and many other insects also cause extensive damage to agricultural plants. Weeds result in further harm, being responsible for reductions of about 12 percent in crop yields and 20 percent in forage yields.

In the past, methyl bromide was seen as an attractive tool for dealing with many of the soil pests farmers faced. Pre-plant treatment of soil with methyl bromide was found to be effective against most nematodes, many weeds, insect larvae, and other soil parasites. While there were obvious economic benefits of methyl bromide, it has now been banned, or is being phased out of use because of its potential threat to the environment. While large sums of money have been spent in the search for environmentally friendly replacements for methyl bromide, no proposed replacement has been adequate. Many other toxic agents have been proposed, or used, that are believed to be less harmful to the environment. However, there remains an unmet need to find safe, environmentally responsible alternatives that can provide some, or all, of the benefits provided by the treatment of soil with methyl bromide, as well as providing other agricultural or horticultural benefits without harming the environment.

In addition to methyl bromide treatment of the soil, many other toxic compounds are routinely used to treat pests above ground, and there remains a need to find alternatives that can be effective against undesirable pests. In several applications, there is a need for compounds that are relatively safe, biodegradable, and/or derived from natural compounds to replace some of the harmful agents currently in use.

Surfactants represent a broad class of compounds that have been explored as tools to assist in the control of pests. A variety of surfactants, including detergents, have been used as adjuvants in pesticidal formulations, often assisting in the application of the active ingredient. Insecticidal soaps have also been proposed for killing or repelling a variety of plant pests such as aphids, mites, and earwigs.

Surfactants per se are known not to be necessarily harmful to nematodes. Indeed, insecticidal soaps and other surfactants have been used in combination with applied nematodes as a means of controlling pests that may be attacked by the nematodes, indicating compatibility or even synergy between the two treatments. For example, H. K. Kaya et al., “Integration of Entomopathogenic Nematodes with Bacillus thuringiensis or Pesticidal Soap for Control of Insect Pests,” Biological Control, 5: 432-441 (1995) reports that nematodes could be applied successfully with pesticidal soaps in the treatment of some pests. Surfactants can be harmful, though, so the authors warn that storing the nematodes in the pesticidal soap solution for over 24 hours is discouraged. Likewise, M. Mutwakil et al., “Surfactant Stimulation of Growth in the Nematode Caenorhabditis elegans,” Enzyme and Microbial Technology, Vol. 20, 1997, pp. 462-470, report that a variety of surfactants at 10 ppm concentration stimulated growth of nematode larvae. Others have reported certain surfactant and nematode combinations have been more harmful to the nematodes.

While past work has explored the role of fatty acids, ethoxylated alcohols, and related materials for various pesticidal purposes, such work generally points to low carbon number surfactants and low HLB numbers. Such conclusions, however, did not help to substantially overcome a major limitation in the prior art, namely, the need for bio-derived surfactants for agricultural and horticultural treatments that reduce many of the environmental and human health risks associated with conventional pesticides.

Carbon dioxide has been proposed for use in combination with chemical pesticides as a carrier. For example, in U.S. Pat. No. 6,627,654, “Anthropod-Controlling Composition,” issued Sep. 22, 2003 to Kubota and Fujinami, a list of possible gaseous carriers for their pyrone-based chemical pesticide mentions carbon dioxide.

US Pat. Application 20070077311, “Fumigant/Sterilant,” published Apr. 5, 2007 by Ryan and Bishop, herein incorporated by reference to the extent that it is noncontradictory herewith, discusses the use of cyanogen as an alternative to methyl bromide for soil fumigation. To compensate for the high flammability of cyanogen, it is proposed that cyanogen be mixed with liquefied or gaseous carbon dioxide to keep cyanogen below its flammability limit.

While carbon dioxide in various forms has been proposed as a carrier in the application of some chemical pesticides or as a fumigant, its combination with environmentally friendly surfactants to provide an effective, environmentally friendly pesticidal soil treatment free of conventional pesticides is believed to be novel, as are the associated methods of using such soil treatments to assist carbon dioxide generators such as coal-fired power generating companies in reducing their anthropogenic CO2 emissions or in increasing CO2 sequestration.

### SUMMARY OF THE INVENTION

A surprising discovery has been made contrary to some aspects of general understanding in the agricultural and pesticidal arts, showing that relatively non-toxic, bio-derived surfactants obtained from naturally occurring lipids such as vegetable oils can be used effectively to replace at least some applications of methyl bromide or other conventional harmful pesticides. It has been discovered that these surfactants can be applied to soil in combination with carbon dioxide to enhance carbon dioxide sequestration or plant uptake of carbon dioxide (CO2), while also providing pesticidal benefits in the soil. In some embodiments, synergistic effects may be obtained between the carbon dioxide and the surfactant application, such as benefits in fighting populations of unwanted nematodes in which both carbon dioxide and surfactants play a role. Further synergy may be obtained in terms of carbon sequestration or carbon uptake by plants, in that the presence of the surfactants can improve penetration of CO2-enriched liquid into the ground, or may permit a more favorable distribution of the liquid in the soil, although other mechanisms may be involved and we do not wish to be limited by theory in identifying potential mechanisms for benefits delivered by some embodiments of the present invention.

The delivery of carbon dioxide to the soil can be achieved through a variety of means, such as by using carbonated water or combining pressurized CO2 with surfactants that are being applied to the soil. Carbon dioxide may be provided on site in liquid or solid form, with gaseous or liquid streams of pure CO2 or CO2 in combination with other gases or liquids being directed to the soil or to a mixing system to combine the CO2 with an aqueous solution of surfactants and other agents, after which the mixture is applied to the soil.

In some embodiments of the present invention, a method for soil treatment comprises providing elevated levels of carbon dioxide to soil in combination with effective amounts of surfactants in an aqueous solution, the solution being substantially free of conventional chemical pesticides yet nevertheless providing protection from one or more types of pests such as nematodes, harmful insects, and weeds. The surfactants can have eight or more carbons, twelve or more carbons, fourteen or more carbons, sixteen or more carbons, or eighteen or more carbons. The surfactants may be bio-derived surfactants obtained from a natural lipid such as vegetable oils, wherein the fatty acids are reacted with one or more compounds such as ethylene oxide to create a surfactant that is an ester of a fatty acid.

In some embodiments of the present invention, carbon dioxide is delivered to soil in the presence of surfactants having a pesticidal effect against one, two, or more types of pests. The surfactants may be bio-derived surfactants comprising fatty acid esters (e.g., ethoxylates of fatty acids) and may have relatively high carbon numbers and/or high HLB values. While some related bio-derived surfactants have been used as adjuvants in some pesticide formulations, they are not believed to have been previously considered as effective replacements for methyl bromide or other environmentally harmful soil pesticides due to the general understanding that they are relatively non-toxic. The present discovery of the pesticidal benefits of some bioderived surfactants was not based upon consideration of past work on surfactants and insect populations, but was found though serendipity in exploring the cleaning effects of certain bio-based cleaning compounds derived in part from vegetable oils. The first such observation, based on work done in the southern United States, was that plants in areas that had been treated with a bio-derived surfactant composition showed better growth. The surfactant was applied to a water tank in hopes of reducing mold growth. The dilute aqueous surfactant solution was then used for cleaning the outer surfaces of a home. Not only did the plants near the treated surfaces show improved vitality, but there was a second observation that insects entering the home from the outside were substantially reduced in number. This discovery inspired consideration of the possibility that a safe, “green” composition being used for cleaning purposes might have unexpected uses in agriculture and horticulture, including pesticidal uses.

Further exploration of the effects of said cleaning compounds led to the surprising discovery that they were highly effective against a variety of harmful soil pests that afflict citrus crops and other crops, including parasitic nematodes, which are not insects. In spite of the bio-derived compounds being relatively mild and nontoxic with respect to humans, and in spite of past teachings that might suggest such compounds would not be effective, a series of experiments has confirmed that the compounds of the present invention can be used against a variety of pests, including parasitic nematodes, root weevils (e.g., Diaprepes abbreviatus), etc., and that CO2 can be used successfully in combination with such surfactants.

What has been particularly surprising is that the bio-derived surfactants of the present invention typically are not directly toxic to insect pests such as root weevil larvae, yet are nevertheless effective in reducing damage from the pests. Traditional toxicity tests used to identify potential pesticides measure the kill rate or the lethal dose to kill a portion of the population, but may overlook other benefits outside of lethal toxicity. We have observed, for example, that some bio-derived surfactant solutions that do not kill root weevils nevertheless cause them to be substantially less active and less healthy, bringing substantial benefits in reducing plant damage without being lethal. Thus, we propose that the potential of bio-derived non-lethal surfactants in insect control has not been recognized in the past in part because of the generally low toxicity of such compounds toward various species as measured with standard toxicological methods.

Further, we have surprisingly found that some bio-derived surfactants and compositions within the scope of the present invention share some of the broad-spectrum efficacy of methyl bromide in the sense that they can be effective against two or more classes of pests such as nematodes, insect larvae or pupae, and weeds. Yet also surprisingly, some such compounds have low phytotoxicity, unlike methyl bromide, such that effective amounts of the bio-derived pesticidal compounds can be applied directly to crops or other plants, or to the soil around growing plants, without serious harm to the desired plant. And in combination with the growth-promoting benefits of carbon dioxide, the combination of effective bio-derived pesticidal surfactants with low phytotoxicity and enhanced levels of carbon dioxide can result in substantial benefits for plants, such as increased crop yield, improved quality, or improved disease resistance.

In some embodiments of the present invention, an aqueous solution comprising surfactants that are effective against one or more targeted pests is combined with carbon dioxide to provide a mixture having elevated carbon dioxide levels, such as a concentration of available carbon dioxide (including as a solute, adsorbent, or gas) that is at least 50% greater, at least 100%, at least 200% greater, or at least 500% greater than would have resulted without providing a carbon dioxide source other than ambient air. For example, the water may be carbonated prior to, after, or during mixing of the water with the bio-derived surfactant, and the resulting solution may be carbonated sufficiently to provide generation of bubbles at nucleation sites, or to at least comprise carbonic acid or reaction products of carbonic acid, such that the solution can deliver additional carbon to the crops obtained from the provided carbon dioxide. The surfactants may also be added to carbonated water or other carbonated liquids.

In testing the combination of carbon dioxide with the bio-derived surfactants of the present invention, it has been observed that carbon dioxide may have synergistic effects with the bio-derived surfactants. For example, it has been observed that carbon dioxide can anesthetize many insects, including larvae of root weevils as well as nematodes.

Without wishing to be bound by theory, it is possible that the effect of carbon dioxide may enhance the effectiveness of the bio-derived surfactant solution by at least temporarily decreasing any coping mechanisms the targeted pests might have in response to the presence of the surfactant, such as reducing the ability to flee to areas of lower surfactant concentration. For example, in treating nematodes, carbon dioxide may provide for immobility of the nematodes while the surfactant breaks the surface tension of the fluid in the surrounding its exterior sheath, allowing the nematode to drown or to be exsheathed. Modification of the physical interaction with the soil or modification of the pH may also play a role in delivering some benefits. The ability of carbon dioxide to stimulate root growth and plant growth in general may also contribute to a beneficial effect on plants treated with carbon dioxide in combination with a bio-derived surfactant. The ability of the surfactant to improve penetration of a solution into the soil may also play a positive role in enhancing carbon dioxide sequestration and biological uptake. The role of carbon dioxide on other organisms in the soil can also be a consideration when to use carbon dioxide most effectively.

In some embodiments, carbon dioxide may be used to atomize a treatment solution and apply it to the ground or to above-ground plant structures, resulting in further delivery of carbon dioxide that can be available for uptake by plants.

The invention is also directed to methods of applying bio-derived compositions to soil or plants in the presence of elevated CO2 levels, wherein the bioderived compositions comprise surfactants derived from natural lipids, such as vegetable oils and naturally occurring fatty acids or their naturally occurring derivatives such as mono-, di-, or triglycerides or phospholipids. In some embodiments, agricultural and horticultural treatments comprise application of CO2 with bio-derived surfactants obtained from natural oils such as soybean and castor oils, wherein the surfactants are obtained by esterification of the oils to add alkoxy groups such as methoxy, ethoxy, or propoxy groups. In some embodiments, the bio-derived surfactants have aliphatic chains with relatively high carbon numbers, such as 14 or more carbons, 16 or more carbons, or 18 or more carbons. In one embodiment, the carbon number is from 16 to 18, and in a related embodiment, the bio-derived surfactant primarily comprises surfactants having a carbon number of 16 or 18, or more specifically, a carbon number of 18.

In another embodiment, the bio-derived surfactant comprises an ethoxylated fatty acid, wherein the fatty acid has a carbon number of sixteen or greater and/or at least 5 ethoxy groups, specifically at least 10 ethoxy groups, and more specifically at least 20 ethoxy groups, such as between 5 and 80 ethoxy groups, or between 10 and 60 ethoxy groups, or between 15 and 55 ethoxy groups. In one embodiment, the bio-derived surfactant is obtained by esterification or epoxidation of soybean or castor oil. More generally, but by way of example only, the bio-derived surfactant may be derived from any of the following lipids: soybean oil, castor oil, cottonseed oil, linseed oil, canola oil, safflower oil, sunflower oil, peanut oil, olive oil, sesame oil, coconut oil, walnut oil or other nut oils, flax oil, neem oil, meadowfoam oil, other seed oils, fish oils, animal fats, and the like. Exemplary fatty acids include omega-3 fatty acids such as alpha-linolenic acid, stearidonic acid, eicosapentaenoic acid, docosahexaenoic acid, and so forth; omega-6 fatty acids such as linoleic acid, gamma-linolenic acid, dihomo-gamma-linolenic acid, arachidonic acid, calendic acid, and the like; omega-9 fatty acids such as oleic acid, erucic acid, elaidic acid, and the like; saturated fatty acids such as myristic acid, palmitic acid, stearic acid, dihydroxystearic acid, arachidic acid (eicosanoic acid), behenic acid (docosanoic acid), lignoceric acid; and other fatty acids including various conjugated linoleic acids, omega-5 fatty acids such as myristoleic acid, malvalic acid, sterculic acid. Natural waxes or the fatty acids therefrom may also be used, particularly ester waxes such as straight chain ester waxes; examples include jojoba oil, carnauba wax, beeswax, candellia wax, and the like.

In some embodiments, the bio-derived surfactants of the present invention comprise surfactants derived from naturally occurring fatty acids that are unsaturated, such as omega-3, omega-six, or omega-nine fatty acids, and wherein the aliphatic tail of the surfactant has not been hydrogenated, such that it has remained unsaturated. The iodine number test can be used to assess the degree of saturation. Generally, a highly saturated fatty acid will have an iodine value of less than 5 (e.g. less than 2).

In some embodiments, bio-derived surfactants are obtained from two or more vegetable oil sources, such as from mixtures of any two or more of the vegetable oils mentioned herein. Alternatively, two or more vegetable oils may be reconstituted to form a reconstituted oil according to known methods such as those described in U.S. Pat. No. 6,258,965, “Reconstituted Meadowfoam Oil,” issued Jul. 10, 2001 to A. J. O'Lenick, Jr., and U.S. Pat. No. 6,013,818, “Reconstituted Meadowfoam Oil,” issued Jan. 11, 2001 to A. J. O'Lenick, Jr., both of which are herein incorporated by reference to the extent that it is noncontradictory herewith. The O'Lenick patents describe processes in which one or more oils of natural origin are transesterified under conditions of high temperature in the presence of a catalyst to make a “reconstituted product” having an altered alkyl distribution and consequently altered chemical and physical properties. While surfactants obtained from natural lipids are useful, it is recognized that identical materials obtained from synthetic raw materials can be created and, in some embodiments, are still within the scope of the present invention.

In one embodiment, the compositions of the present invention can include a mixture of the water blended in any suitable ratio with the following compounds:
20 to 100 parts of a polyethoxylated vegetable oil with an average degree of ethoxylation greater than 10 (greater than 10 ethoxy groups per fatty acid chain).
0 to 100 parts of a vegetable oil methyl ester.
0 to 100 parts vegetable oil.
0 to 10 parts pentanedioic acid, dimethyl ester.
0 to 10 parts butanedioic acid, dimethyl ester.
0 to 10 parts hexanedioic acid, dimethyl ester.
0 to 50 parts polyoxyethylene tridecyl ester.
0 to 20 parts ethoxylated alkylaryl phosphate ester.

The treatments of the present invention can be further enhanced through the additional application of carbon dioxide, such as by carbonating the water used to form the solution or carbonating the solution after all or most of its components have been mixed together. Carbonation can be used to deliver carbon dioxide into the soil where it can enhance the available carbon dioxide for root uptake, or where it may enhance the pesticidal effects of the solution. For example, in some cases the presence of carbon dioxide (e.g., as gas bubbles, in solution as carbonic acid, etc.) or its reaction products (carbonates, etc.) can help mitigate the effects of harmful fungi, bacteria, larvae, nematodes, etc. Our observations indicate that carbon dioxide can paralyze or reduce the activity of many living pests, and, without wishing to be bound by theory, suggest that the presence of elevated levels of carbon dioxide or its reaction products at concentrations sufficient to reduce activity or defenses of some pests may make the pests more susceptible to the harmful effects of the bio-derived surfactants or other components of the aqueous solutions for treatments according to the present invention. In some embodiments, carbon dioxide gas may be applied directly onto or into the soil, either during, before, or after treatment with the aqueous solutions of the present invention, such that elevated levels of carbon dioxide or its reaction products are present in the soil that is treated with bio-derived surfactants.

The methods of the present invention can be combined with a variety of business models involving transactions related to carbon credits or other credits or payments for reducing carbon dioxide emissions. For example, in one embodiment, the land used to receive elevated CO2 concentrations according to the methods of the present invention are owned, rented by, or made available to entities (companies, government, universities, etc.) that generate anthropogenic CO2. Sequestration of a portion of the applied CO2 in the soil by the soil and living matter growing in the soil can be used to receive carbon credits that may reduce or offset the carbon emissions of the entity. “Carbon credits” may be received for the treatment of the soil with CO2 according to the present invention. Carbon credits are a component of national and international emissions trading schemes aimed at reducing greenhouse effect emissions on an industrial scale by capping total annual emissions and letting the market assign a monetary value to any shortfall through trading. Credits can be exchanged between businesses or bought and sold in international markets at the prevailing market price. Credits can be used to finance carbon reduction schemes. Guidelines and validation of carbon credit transactions can be done in collaboration with the United Nations Framework Convention on Climate Change (UNFCC).

For trading purposes, one allowance or Certified Emission Reduction is typically considered equivalent to one metric tonne of CO2 emissions. These allowances can be sold privately or in the international market at the market price, with international transfers validated by the UNFCCC. Transfer in the European Union is additionally validated by the European Commission. Carbon prices are normally quoted in Euros per tonne of carbon dioxide or its equivalent (CO2e).

Currently there are at least four exchanges trading in carbon allowances: the Chicago Climate Exchange, European Climate Exchange, Nord Pool, and PowerNext. Many companies can now participate in emissions abatement, offsetting, and sequestration programs to generate credits. Several companies also sell carbon credits to companies and organizations seeking to voluntarily reduce their carbon footprint.

Thus, in light of the methods for applying carbon dioxide to soil and plants, as described herein, a variety of transactions related to carbon credits can ensue. For example, farmers or groups representing farmers may collaborate with CO2 producers or intermediaries having access to anthropogenic CO2 producers to receive carbon dioxide for use according to the methods of the present invention to enhance crops or other plants. In exchange for the carbon credits that those providing the CO2 can receive, the farmers may receive free or reduced cost access to equipment for delivering the CO2 into soil, and may optionally receive reduced rates for the surfactants or other materials needed for effective soil treatment according to the present invention.

Thus, one embodiment of the present invention is a method for facilitating reduction in CO2 emissions by a CO2 producer, comprising the CO2 producer providing a source of carbon dioxide that can be delivered to an agricultural partner, the CO2 producer providing a financial incentive to the agricultural partner to receive the carbon dioxide, the agricultural partner accepting delivery of the carbon dioxide, the agricultural partner applying the carbon dioxide to soil in combination with a surfactant, and the CO2 producer receiving carbon credits for at least a portion of the CO2 delivered to the agricultural partner.

Alternatively, one embodiment of the present invention is a method for facilitating reduction in CO2 emissions by a CO2 producer, comprising providing an incentive to the CO2 producer to provide carbon dioxide to an agricultural partner, delivering CO2 from the CO2 producer to the agricultural partner, the agricultural partner applying the carbon dioxide to soil in combination with a surfactant, wherein at least a portion of the applied CO2 is sequestered by at least one of the soil and plant matter growing in the soil, and wherein the application of the carbon dioxide in combination with a surfactant to the soil results in reducing the activity of a pest harmful to a desired plant that is planted in the soil. The incentive to the CO2 producer may comprise carbon credits that can be traded in a carbon credit market.

A governmental body, regulatory agency or company authorized to administer carbon credits may offer the incentives to either or both parties and/or administer or recommend the awarding of incentives, and may also provide means for carbon audits to validate the efficacy of the agricultural partner's actions in sequestering CO2. Carbon balances may be performed using chemical analytical techniques to measure carbon uptake by plants and soil, CO2 concentrations in the soil, released CO2 that escapes from the soil, etc. Released CO2 may be monitored using isolation tents over portions of the treated ground to continuously monitor CO2 concentrations leaching from the soil over a period of hours to days after treatment.

### BRIEF DESCRIPTION OF THE FIGURES

FIG. 1 shows a mixing section for combining pressurized carbon dioxide with a surfactant solution according to the present invention.

FIG. 2 depicts a subsurface injection unit according to the present invention for delivering an aqueous surfactant solution in the presence of pressurized carbon dioxide gas into the soil.

FIG. 3 shows the end of the main body of a subsurface injection unit according to the present invention.

FIG. 4 shows the above-ground control system for use with a subsurface injection unit, according to the present invention.

### DEFINITIONS

As used herein, “bio-derived” compounds are those produced from a naturally occurring substance obtained from a plant, animal, or microbe, and then modified via chemical reaction. Modification can include esterification of fatty acids (e.g., ethoxylation, methoxylation, propoxylation, etc.), transesterification of an oil (e.g., reaction of an alcohol with a glyceride to form esters of the fatty acid portions of the glycerides), etc. Hydrogenation or other steps may also be considered.

As used herein, “chemical pesticides” are synthetic compounds with pesticidal activity against pests such as insects, nematodes, fungus, weeds, bacteria, etc. Pesticidal activity is expressed through directly killing or inactivating the pest. Most conventional pesticides are chemical pesticides. Various types of chemical pesticides can include organophosphate pesticides (pesticides that affect the nervous system by disrupting the enzyme that regulates acetylcholine, a neurotransmitter), carbamate pesticides (agents that attack the nervous system by disrupting an enzyme that regulates acetylcholine), organochlorine insecticides (e.g., DDT and chlordane), pyrethroid pesticides (synthetic versions of the naturally occurring pesticide pyrethrin), etc.

As used herein, “biopesticides” are pesticidal agents obtained from natural materials such as animals, plants, bacteria, and certain minerals. For example, canola oil and baking soda have pesticidal applications and are considered biopesticides by the EPA. Classes of biopesticides include microbial pesticides having a microorganism (e.g., a bacterium, fungus, virus or protozoan) as the active ingredient; plant-incorporated-protectants (PIPs) produce from genetic material that has been added to a plant; and biochemical pesticides that occur naturally and control pests by non-toxic mechanisms. Biochemical pesticides include substances, such as insect sex pheromones, that interfere with mating, as well as various scented plant extracts that attract insect pests to traps. Because it is sometimes difficult to determine whether a substance meets the criteria for classification as a biochemical pesticide, EPA has established a special committee to make such decisions.

As used herein, “essential oil” is defined as a volatile and frequently aromatic liquid obtained from plants and seeds, including but not limited to cotton seed oil, soybean oil, cinnamon oil, corn oil, cedar oil, castor oil, clove oil, geranium oil, lemongrass oil, linseed oil, mint oil, sesame oil, thyme oil, rosemary oil, anise oil, basil oil, camphor oil, citronella oil, eucalyptus oil, fennel oil, ginger oil, grapefruit oil, lemon oil, mandarin oil, orange oil, pine needle oil, pepper oil, rose oil, tangerine oil, tea tree oil and tea seed oil, or individual components thereof such as benzaldehyde, cinnamaldehyde, etc.

As used herein, “soil” refers to all media capable of supporting the growth of plants and may include humus, sand, manure, compost and the like. Soil may be substantially uniform in properties or substantially heterogeneous at a variety of scales. For example, there may be multiple strata such as a layer of sandy soil above a less permeable layer of clay-rich soil. There may also be aggregates of differing soil types, or clumps of matter such as vegetable matter, clays, minerals, fertilizers, etc., dispersed within the soil. The soil may also contain manmade ducts, tubes, pipes, shafts, etc., for convenient irrigation or treatment with nutrients, pesticides, etc., though such structures are generally understood to not be part of the soil itself. The soil may be substantially flat, in mounds, interspersed with furrows, in pots or other containers, in the outdoors or in a greenhouse, etc. In some cases, the soil is part of an outdoor agricultural field dedicated to growing of one or more marketable crops. Such a field may have an area of at least 1 hectare, at least 10 hectares, or at least 100 hectares, such as from 10 to 100,000 hectares or from 100 to 10,000 hectares. The field may comprise a single contiguous area or may be broken up into a plurality of nearby units controlled by the same entity.

### DESCRIPTION OF THE DRAWINGS

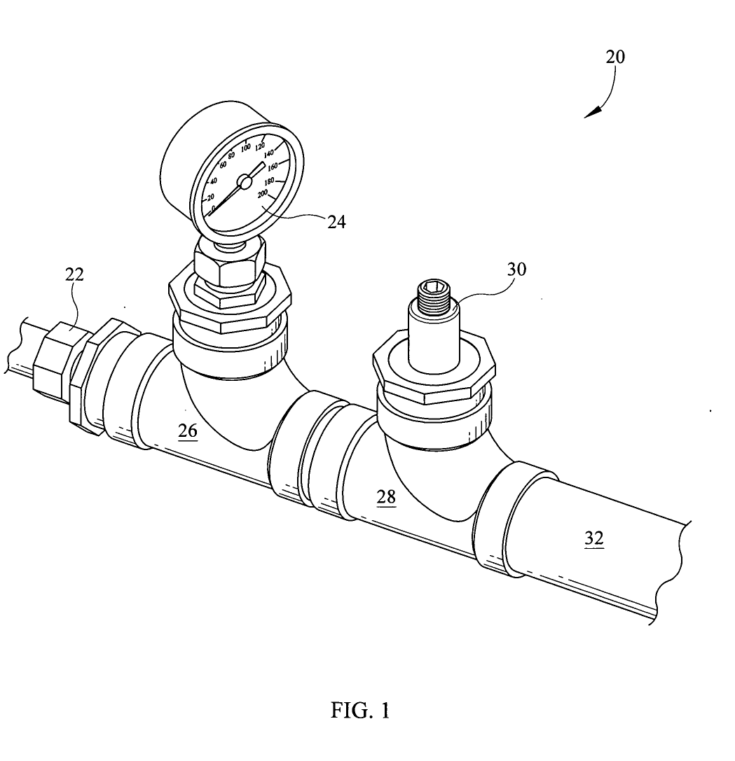

FIG. 1 is a drawing of an injection unit 20 for an above-ground spray application system for combining carbon dioxide and an aqueous solution of a surfactant. The injection unit 20 shown has an inlet line 22 for receiving a metered flow of an aqueous solution of a surfactant. A pressure gauge 24 in a first sweep-T junction 26 allows the carbon dioxide pressure into the injection unit 20 to be monitored. A carbon dioxide line 30 allows carbon dioxide to merge into the liquid flow in a second sweep-T junction 28. The combined liquid and carbon dioxide flows enter a continuation segment 32 where CO2 contact with the liquid continues under pressure, and from when it may be delivered to a spray tank or other spray system (not shown).

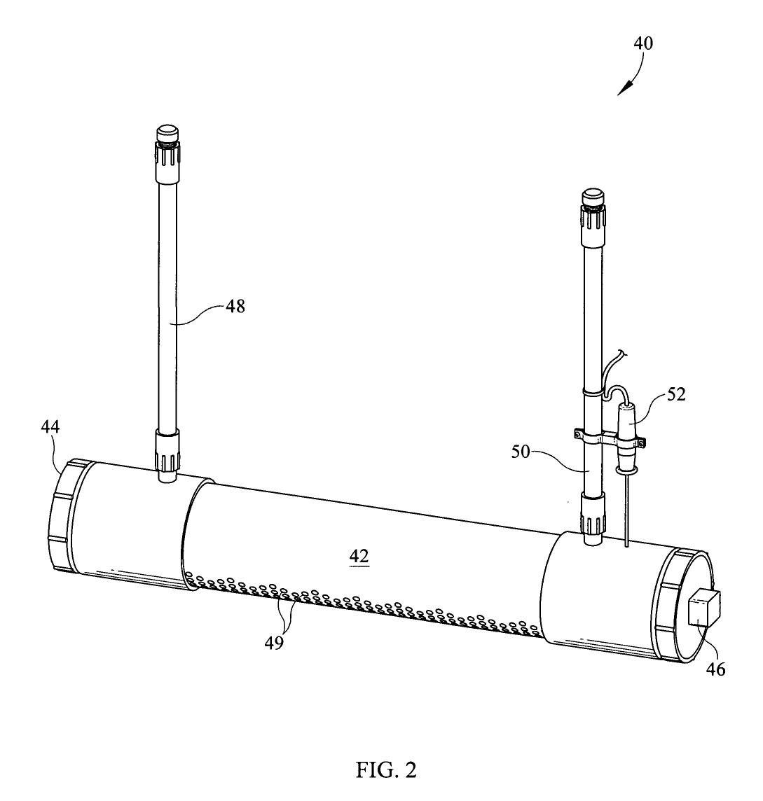

FIG. 2 depicts a subsurface injection unit 40 for delivering an aqueous surfactant solution in the presence of pressurized carbon dioxide gas into the soil while buried a predetermined depth, such as from 20 to 80 cm below the surface. The subsurface injection unit 40 has a main body 42, in this 8-inch diameter PVC piping, with end caps 44 and 46. A liquid entrance line 48 allows metered aqueous solutions of surfactants to be delivered into the main body 42, which has fine holes 49 drilled in the lower half through which the pressurized liquid is exuded into the soil (not shown). A carbon dioxide inlet line 50 allows pressurized carbon dioxide gas to be supplied to the main body 42, from whence it can be delivered with the liquid into the surrounding soil through the fine holes in the main body (not shown). A thermocouple 52 extends through an end cap 46 to allow temperature to be monitored near the carbon dioxide inlet line to allow the system to be controlled to prevent freezing of the liquid.

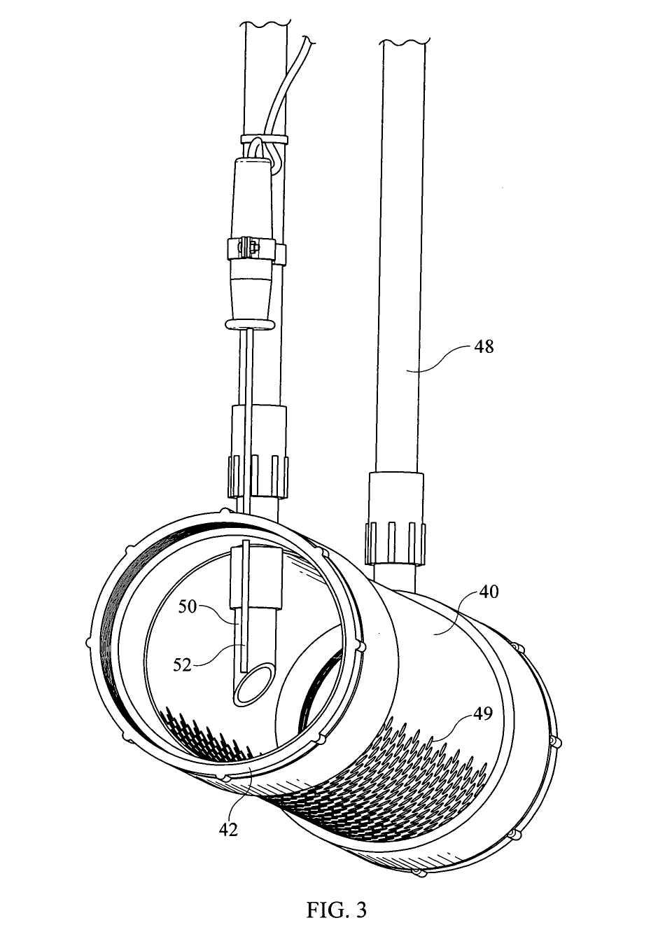

FIG. 3 depicts the end of the main body 42 of the subsurface injection unit 40 with end cap 46 removed to allow the interior of the subsurface injection unit 40 to be seen. The thermocouple 52 near the end of the carbon dioxide inlet line 50 is visible.

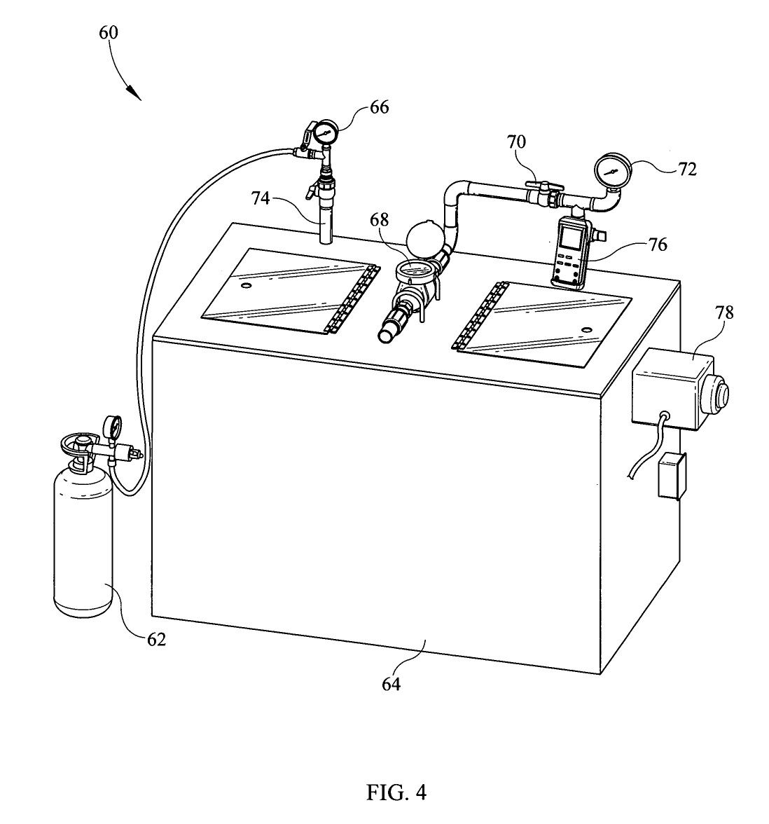

FIG. 4 is a drawing of the above-ground control system 60 for use with the subsurface injection unit 40 of FIGS. 2 and 3. A carbon dioxide tank 62 serves as a source of pressurized CO2 that flows into CO2 line 74 with pressure monitored by a gas pressure gauge 66. An aqueous solution of a surfactant is provided from a liquid tank (not shown) which delivers liquid to a peristaltic metering pump 78 whose output pressure is monitored by a liquid pressure gauge 72 and whose mass flow rate is monitored by a mass flow meter 68. A liquid valve 70 is shown in the open position. The liquid exiting from the mass flow meter 68 can pass through a hose (not shown) or other tubing to connect to a subsurface injection system (not shown). Inside the control box 64 is a carbon dioxide sensor (not visible). A digital thermometer 76 monitors line temperatures. The control box 64 can be placed over a buried injection line to monitor escaping carbon dioxide that emerges from the soil.

### DETAILED DESCRIPTION OF THE INVENTION

### The Composition and Methods of Making

The carbon dioxide sequestration and delivery systems of the present invention can be done with a variety of surfactant solutions, particular with certain bio-derived surfactants which have been discovered to have unexpected benefits in reducing the activity of pests. Formation of a bio-derived surfactant from a naturally occurring lipid can be done by any known method such as esterification, Fischer esterification, epoxidation, etc. Prior to the formation of a surfactant, fatty acids may be liberated from natural lipids by, for example, triglyceride hydrolysis, which separates the fatty acids from glycerol. The fatty acids may then be reacted to yield the bio-based surfactants useful in the present invention. In one version, the reaction of the fatty acids is with an alcohol or an epoxide. Exemplary alcohols include methanol, ethanol, propanol, and other primary or secondary alkyl alcohols.

In ethoxylation, ethylene oxide is added to fatty acids, typically in the presence of potassium hydroxide, resulting in the addition of multiple ethoxy groups to the acid. In order to obtain a bio-derived surfactant with a relatively high HLB value that is the product of a natural fatty acid, ethoxylation is a useful technique because a chain of hydrophilic ethoxy groups can be readily added to the molecule. Thus, in many embodiments of the present invention, the bio-derived surfactants are obtained through a simple operation or small number of operations from the natural raw materials themselves, such as via hydrolysis and esterification (e.g., ethoxylation) or via esterification alone. In other embodiments, a hydrogenation step may also be included prior to or after esterification (e.g in the formation of alcohols, hydrogenation may follow methylation of a fatty acid).

Bio-derived surfactants may be produced from any known method of ethoxylating triglycerides such as vegetable oils, including the methods discussed in U.S. Pat. No. 6268517, “Method for Producing Surfactant Compositions,” herein incorporated by reference to the extent that it is noncontradictory herewith.

In one embodiment, the bio-derived surfactant is an ethoxylated mono-, di-, or triglyceride prepared by the condensation of ethylene oxide with a mono-, di-, or triglyceride. The reaction may be performed using from 5-70 moles, 10-50 moles, or 20-50 moles of ethylene oxide per mole of mono-, di-, or triglyceride. The resulting condensation product may have a melting point of at least 15° C., at least 25° C., or at least 30° C.

As discussed by Ernst W. Flick in Industrial Surfactants, 2nd ed., p. 230, ethoxylated fatty acids and polyethylene glycol fatty acid esters are nonionic mono and diesters of various fatty acids, typically prepared by the condensation or addition of ethylene oxide to a fatty acid at the site of the active hydrogen or by esterification of the fatty acid with polyethylene glycol. The chemical structure of the monoester product is generally R—CO—(O—CH2CH2)n-OH where R—CO represents the hydrophobic base and n denotes the mole ratio of oxyethylene to the base. The diester product has a chemical structure of R—CO—(O—CH2CH2)n-O—CO—R.

U.S. Pat. No. 6,300,508, “Thickened Aqueous Surfactant Solutions,” issued Oct. 9, 2001 to Raths, Milstein, and Seipel, herein incorporated by reference to the extent it is compatible herewith, describes a method for the production of fatty acid esters of an ethylene-propylene glycol of the formula R1 COO(EO)x(PO)y(EO)zH wherein R1 CO is a linear aliphatic, saturated or unsaturated acyl group, or a combination thereof, having from about 6 to about 22 carbon atoms (though a more specific range of 14 to 22 or 16 to 22 carbon atoms may be considered for the purposes of the present invention), EO is —CH2CH2—, and PO is —CH2CH(CH3)O—or —CH2CH2CH2O—or a combination thereof. The method of U.S. Pat. No. 6,300,508 comprises reacting a fatty acid having from about 6 to about 22 carbon atoms with an alkylene oxide selected from the group consisting of propylene oxide, ethylene oxide or a combination thereof, in the presence of an alkanolamine. For some embodiments of the present invention, the use of additional moles of alkylene oxide reactants relative to the recommendations of U.S. Pat. No. 6,300,508 may be considered to increase the degree of ethoxylation or propoxylation and thereby increase HLB.

U.S. Pat. No. 6,221,919, “Utilization of Ethoxylated Fatty Acid Esters as Self-Emulsifiable Compounds,” issued Apr. 24, 2001 to G. Trouve, herein incorporated by reference to the extent that it is noncontradictory herewith, discloses methods of producing ethoxylated fatty acid esters that may have one or more of the following three formulas:

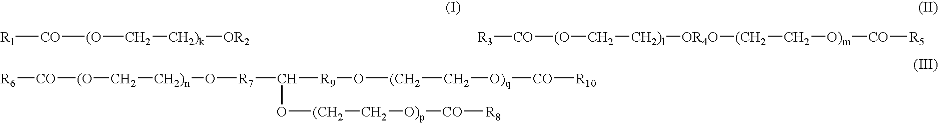

where R1, R3, R5, R6, R8 and R10 represent a linear or branched, saturated or unsaturated hydrocarbon chain having from 5 to 30 carbon atoms (for the purposes of the present invention, these may more specifically have from 14 to 30 carbon atoms), and R2, R4, R7 and R9 represent a linear or branched, saturated or unsaturated hydrocarbon chain having from 1 to 5 carbon atoms. U.S. Pat. No. 6,221,919 teaches that the values of k, l+m, and n+p+q should be adapted to give HLB values between about 4 and about 10, preferably neighboring 5, although higher HLB values are within the scope of the present invention, so elevated values of k, l+m, and n+p+q may be useful.

Example 2 described by U.S. Pat. No. 6,221,919 is specifically incorporated herein by reference, for it describes ethoxylation of rapeseed oil via a process that may be useful for a variety of other vegetable oils within the scope of the present invention.

Ethoxylation is most easily performed by direct condensation reactions with ethylene oxide with fatty acids or fats themselves. Ethoxylation can also be carried out on fatty acid methyl esters if the appropriate catalysts are used, as described by I. Hama, T. Okamoto and H. Nakamura of Lion Corporation, Tokyo, Japan, in “Preparation and Properties of Ethoxylated Fatty Methyl Ester Nonionics,” Journal of the American Oil Chemists' Society, Vol. 72, No. 7, July, 1995, pp. 781-784. Their method directly inserts EO into fatty methyl esters (RCOOCH3) to give [RCO(OCH2CH2)nOCH3] using a solid catalyst modified by metal cations. Ethoxylates of fatty methyl esters obtained by this method were homogeneous monoesters and had good properties as nonionic surfactants.

Fischer esterification involves forming an ester by refluxing a carboxylic acid and an alcohol in the presence of an acid catalyst. Typical catalysts for a Fischer esterification include sulfuric acid, tosic acid, and lewis acids such as scandium(III) triflate or dicyclohexylcarbodiimide.

Vegetable oils, after basic purification, can be processed to produce methylated or ethylated seed oils, commonly referred by the abbreviations MSO and ESO, respectively, which typically have a single moiety added, unlike epoxidation reactions which can add numerous groups. MSO's and ESO's are created by hydrolysis of the glycerol molecule from the fatty acids, and the acids are then esterified with methanol or ethanol. Such compounds can be used in the scope of the present invention, but when higher HLB values are desired, additional hydrophilic groups should be added.

Examples of commercially available compositions comprising bio-derived surfactants that may be used within the scope of the present invention include:
SC-1000™, a surface washing agent marketed by GemTek Products (Phoenix, Ariz.). SC-1000™ is part of GemTek's SAFE CARE® product series, that are said to contain alcohols, fatty acids, esters, waxes, saponifiers, chelators, enzymes and other fractions from soy, corn, palm kernel, peanut, walnut, safflower, sunflower, Canola, and cotton seed, as described at http://www.gemtek.com/pdf/2005-SAFECARE_Brochure.pdf, as viewed Nov. 26, 2007.
SoyFast™ Manufacturer's Base marketed by Soy Technologies (Nicholasville, Ky.) as a soy-based biodegradable all-purpose cleaner, and related soy-based products such as SoyFast™ Cleaner and SoyGreen™ Solvents. Manufacturer's Base, according to its MSDS, comprises two bio-derived surfactants, ethoxylated castor oil (average degree of ethoxylation said to be about 30) and soybean oil methyl ester (formed by reaction of soybean oil with methanol, resulting in hydrolysis of the triglyceride to yield methylated fatty acids and glycerol). It also comprises pentanedioic acid, dimethyl ester; butanedioic acid, dimethyl ester; hexanedioic acid, dimethyl ester; and polyoxyethylene tridecyl ester.
Soy-Dex Plus marketed by Helena Chemical Co. (Memphis, Tenn.), said to be a proprietary blend of vegetable oil, polyol fatty acid ester, polyethoxylated esters thereof, and ethoxylated alkylaryl phosphate ester.
Esterified vegetable oils, for example from Cognis Corp. (Monheim, Germany), described on page 5 of http://www.cognis.com/NR/rdonlyres/C313D620-45B5-4AEE-834A-8294C94623C9/0/AS ProductCataloque A4 070801 reduced.pdf (as viewed Nov. 2, 2007), including AGNIQUE SBO-10 Ethoxylated Soybean Oil, POE 10; AGNIQUE SBO-30 Ethoxylated Soybean Oil POE 30; AGNIQUE SBO-42 (Trylox 5919-C) Ethoxylated Soybean Oil, POE 42; AGNIQUE SBO-60 Ethoxylated Soybean Oil POE 60; AGNIQUE CSO-44 (Mergital EL 44) Ethoxylated Castor Oil, POE (polyoxyethylene) 44; AGNIQUE CSO-60H (Eumulgin HRE 60) Hydrogenated Ethoxylated Castor Oil, POE 60; AGNIQUE CSO-200 (Etilon R 200) Ethoxylated Castor Oil, POE 200; AGNIQUE RSO-0303 (Eumulgin CO 3522) Alkoxylated Rapeseed Oil, POE 3, POP (polyoxypropylene) 3; AGNIQUE RSO-2203 (Eumulgin CO 3526) Alkoxylated Rapeseed Oil, POE 3, POP 22; AGNIQUE RSO-30 (Eumulgin CO 3373) Ethoxylated Rapeseed Oil, POE 30. Also, Ethoxolated Soybean Oil, marketed by Adjuvants Unlimited of Memphis, Tenn.; as AU970 could be used.
TOXIMUL® ethoxylated castor oils from Stepan Chemical (Northfield, Ill.), including TOXIMUL® 8240 (POE-36), TOXIMUL® 8241 (POE-30), and TOXIMUL® 8242 (POE-40).
Genapol surfactants by Hoechst Chemical, such as Genapol OXD-080, a fatty alcohol polyglycol ether.
Ethoxylated castor oil is available as Shree Chem-Co 35 from Shree Vallabh Chemicals (Gujarat, India). In Shree Chem-Co 35, the hydrophobic constituents comprise about 83% of the total mixture, the main component being glycerol polyethylene glycol ricinoleate. Other hydrophobic constituents include fatty acid esters of polyethylene glycol along with some unchanged castor oil. The hydrophilic part (17%) consists of polyethylene glycols and glycerol ethoxylates. In a related compound, Shree Chem-Co 40, approximately 75% of the components of the mixture are hydrophobic. These comprise mainly fatty acid esters of glycerol polyethylene glycol and fatty acid esters of polyethylene glycol. The hydrophilic portion consists of polyethylene glycols and glycerol ethoxylates.
Ethoxylated castor oil and hydrogenated castor oil products marketed by Global Seven Corp. (Franklin, N.J.), as described in the Global Seven Product Guide at http://www.global7.com/brochure.pdf, as viewed Nov. 15, 2007. These products, marketed as emulsifiers, solubilizers, and conditioners, include HETOXIDE C-200, a PEG-200 castor oil compound said to have an HLB of 18.1; HETOXIDE C-81, a PEG-81 castor oil compound said to have an HLB of 15.9; HETOXIDE C-40, a PEG-40 castor oil compound said to have an HLB of 13.0; HETOXIDE C-30, a PEG-30 castor oil compound said to have an HLB of 11.8; HETOXIDE C25, a PEG-25 castor oil compound said to have an HLB of 10.8; HETOXIDE C-16, a PEG-16 castor oil compound said to have an HLB of 8.6; and HETOXIDE C-5, a PEG-5 castor oil compound said to have an HLB of 4.0.

In one embodiment, the bio-derived surfactants of the present invention comprise surfactants obtained by esterification of vegetable lipids. In a particular embodiment, the lipids are selected from soybean oil and castor oil. These may also be derived from single cell organisms, such as bacteria, algae, yeast, and fungi. The major unsaturated fatty acids in soybean oil triglycerides are 7% linolenic acid (C18:3); 51% linoleic acid (C-18:2); and 23% oleic acid (C-18:1). Castor oil is a triglyceride in which about 85% to 95% of the fatty acids are ricinoleic acid (C18:1-OH), about 2% to 6% are oleic acid (C-18:1), about 1% to 5% is linoleic acid (C-18:2), with there being about 0.3% to 1% each of linolenic acid (C18:3), stearic acid (C18:0), palmitic acid (C16:0), and dihydroxystearic acid, with small amounts of some other acids.

Additional steps, such as hydrogenation and dehydrogenation may also be contemplated. In one embodiment, the bio-derived compound comprises an ester of a fatty acid, wherein the fatty acid has not been chemically modified apart from the formation of an ester bond to join the fatty acid to a hydrophilic moiety. Alternatively a bio-derived surfactant useful in some embodiments of the present invention may be the ethoxylated product of a naturally occurring fatty acid or lipid.

The aqueous composition, as applied to the soil, to weeds, directly on pests, or to crops or other plants, may comprise any effective amount of the bio-derived surfactant, such as at a concentration of least about any of the following:
0.05%, 0.1%, 0.2%, 0.3%, 0.5%,1%,1.5%, 2%, 3%, 5%, 10%, or 20%. The concentration may also be less than about any of the following 100%, 50%, 25%, 20%, 10%, 5%, and 3%, and ranges may be formed from any suitable pair of the aforementioned upper and lower bounds, such as from about 0.1% to about 15%.

Other biobased or natural surfactants may be included, such as the rhamnolipids and rhamnolipid derivatives marketed by Jeneil Biosurfactant Company (Saukville, Wisconsin), such as JBR425 (CAS Number: 147858-26-2) as well as those described in U.S. Pat. No. 5,455,232, “Pharmaceutical Preparation Based in Rhamnolipid,” issued Oct. 3, 1995 to Piljac and Piljac, or in U.S. Pat. No. 7,129,218, “Use of Rhamnolipids in Wound Healing, Treatment and Prevention of Gum Disease and Periodontal Regeneration,” issued Oct. 31, 2006 to Stipcevic et al. Lipopeptide biosurfactants such as those produced by Bacillus species may also be included. Natural plant oils may be provided in the form of oil cakes that can be used in combination with the materials of the present invention.

Buffering agents or acidifiers may also be present. Other ingredients may include oils, emulsifiers, thickeners, film-forming agents, particles such as zeolites, calcium carbonate, mica, etc., as well as fertilizers, nutrients, beneficial bacteria, etc.

Plant oils that can be used in the mixture or in additional treatments, including oil cake treatments, can comprise a variety of plant oils such as neem, castor, soybean, mustard, karanj, mahua, etc. Self-emulsifiable esterified fats and fatty acids may also be used, including those prepared according to the principles taught in U.S. Pat. No. 6,221,919, “Utilization of Ethoxylated Fatty Acid Esters as Self-Emulsifiable Compounds,” previously incorporated by reference. The ethoxylated fatty acid esters described therein are said to form self-emulsifiable components without requiring any other surfactant, and are biodegradable.

The composition may further comprise biopesticides and other naturally occurring agents such as essential oils and botanical extracts, including the garlic extracts described in U.S. Pat. No. 6,231,865. Examples of plant extracts or related bio-derived compounds that may be useful in various embodiments of the present invention include, without limitation, grapeseed oil, lecithin, extract of tomato leaves, mustard extracts, oils and soaps derived from the Brassicacae family, clove oil and clove extracts, Burkholderia cepacia extract, neem oil or neem extracts such as Nimbecidine or other extracts or derivatives from mahogany or other trees of the genus Azadirachta, etc. When oils are included, they may be provided as an emulsion, typically as an oil in water emulsion, though aqueous components may be dispersed as a water in oil emulsion.

Another example of naturally derived materials that can be combined with the surfactants or other compositions of the present invention is given in U.S. Pat. No. 5,051,255, “Nematicidal Preparations,” issued Sep. 24, 1991 to Devidas and Crovetti, herein incorporated by reference to the extent that it is noncontradictory herewith.

Two or more compositions may be applied in sequence or substantially simultaneously, such as a pretreatment of soil with an aqueous solution and a subsequent oil-based spray applied to portions of the soil of either the same or different active ingredients.

Compatibility agents that allow simultaneous application of two or more ingredients may also be included, as desired.

Buffering agents may also be present, such as a phosphate salt or citric acid. “Water softening” agents may also be used, such as ammonium sulfate.

The method for making or using the bio-derived surfactant may include providing an antifoam such as Dow Corning A Antifoam manufactured by Dow Chemical of Midland, Mich. The anti-foam agent may be present in a concentration of about 0.1% to 1% by volume, such as about 0.5%. The use of an anti-foam agent may be helpful, for example, when the solution is to be sheared or agitated, or when it is present with carbonated water or water supersaturated with another gas. Vegetable oils, emulsified oils, other lipids, silicone oils or other agents may be present to help reduce foaming when carbonated materials are used in the presence of surfactants.

The bio-derived surfactants and related mixtures of the present invention can be effective against multiple types of pests, such as insects, nematodes, and weeds. Such wide-spectrum functionality is not required to be within the scope of the present invention, but may be advantageously achieved in some embodiments. The pests that can be targeted may include animal pests that attack roots, leaves, or other plant parts. Such pests may be repelled or inactivated with the compositions of some embodiments of the present invention. Such pests can be insects in various stages of life (larvae, etc.). In some cases, the repelled pests may be mammals (e.g., deer, moles, mice, etc.) or birds who are discouraged from consuming plant parts by the presence of the composition on leaves or other parts of the plants. Further, it has been observed in some cases that compositions of the present invention comprising bio-derived surfactants can also be effective in repelling a wide variety of insects above ground, including some flying insects.

Insect pests that can be targeted with methods and compositions of the present invention may include but are not limited to weevils such as root weevils, including citrus root weevils, pepper weevils (Anthonomus eugenii Cano), snout. weevils in general, cotton weevils (boll weevil), alfalfa weevils, grain weevils, or any beetle from the Curculionoidea superfamily or beetles in other families bearing the name “weevil.”

Other pests to be targeted may include, for example, ants, chinch bugs, false chinch bugs, cutworms, the grape bud beetle or any other beetle, leaffolders, phylloxera, borers, leafhoppers, mealybugs, leafrollers, the orange tortrix, thrips, western grapeleaf skeletonizer, spiders, wasps, aphids, psyllids, tuberworm, the silverleaf whitefly, wireworms, mites such as citrus mites, armyworms, various caterpillars and moths, cockroaches, flies, mosquitoes, etc.

Nematodes to be targeted may include the citrus nematode (Tylenchulus semipenetrans), sheath nematodes (Hemicycliophora and the related Hemicriconemoides species), root knot nematodes (Meloidogyne spp.), cyst nematodes (Heterodera spp.), lesion nematodes (Pratylenchus spp.), stubby root nematodes (Trichodorus spp.), foliar nematodes (Aphelenchoides spp.), and the like.

The term “weeds” refer to any undesired plant species that interferes with the growth and harvesting of planted crops. They may be native or non-native plants (invasive weeds). Examples include broadleaf plantain, burdock, creeping charlie, dandelion, goldenrod, kudzu, leafy spurge, milk thistle, poison ivy, ragweed, sorrel, sumac, wild carrot, wood sorrel, leafy spurge, melaleuca, Old World climbing fern, giant salvinia, salt cedar, hydrilla, water hyacinth, yellow star thistle, downy brome, Brazilian pepper, jointed goat grass, purple loosestrife, and many more.

In one embodiment, a method of the present invention may produce two or more functions that effectively reduce the damage to a crop from at least two differing types of pests, the functions being selected from reducing the activity of insects, reducing the activity of nematodes, and harming weeds by at least one of preventing germination, stunting the growth of existing weeds, or killing weeds. The method in some embodiments may further be effective against disease pathogens (e.g., viruses, bacteria, and fungi).

Crops that may be assisted with the methods and compositions of the present invention may include citrus, strawberries, peppers, tomatoes, beans such as soybeans, celery, squash, grapes (e.g., Tokay grapes), melons, avocado, garden vegetables, apples and other fruit trees, etc., and a wide variety of other fruits, vegetables, legumes, tubers, grains such as corn or wheat, nuts, and the like, as well as non-edible agricultural products such as cotton, trees, grass, alfalfa, ornamental plants and trees, etc. Crops be intended for human consumption, animal consumption (including fodder), or for non-food purposes (e.g., biomass, materials for construction, drug production, etc.).

Uses of the present invention need not be limited to crops that are harvested but can also be applied to enhance plant grown for non-crop purposes such as for aesthetic and ornamental purposes, environmental management, etc.

### Methods of Use

The compositions of the present invention, in combination with elevated levels of carbon dioxide, may be suitable for a variety of agricultural and horticultural applications. Treated crops can include citrus crops, other fruit trees such as apples or cherries, berries such as strawberries, tomatoes, beans such as soybeans, root and tuber products such as beets and potatoes, legumes such as lentils, peanuts or peas, seed crops such as sunflowers or rapeseeds, etc. Ornamental plants, shrubs, trees, lawns, flowers, gardens in general, etc. may also be treated within the scope of the present invention.

The compositions of the present invention may be applied to the soil prior to planting, or after planting but before emergence of the desired plant, or after emergence. When used for control of weeds (herbicidal applications), the bio-derived surfactant may be applied to pre-emergent or post-emergent weeds, though pre-emergent treatment should be most effective since the bio-derived surfactants of the present invention are typically relatively non-toxic to post-emergent plants. In one embodiment, an agricultural field or rows thereof are wetted or flooded with an aqueous solution of the present invention, and the crop or other desired plants are planted immediately or shortly thereafter. The delay between treatment and planting may be, for example, about 5 minutes or greater, such as from about 5 minutes to 1 week, or less than three days, less than one day, or from about 1 hour to about 2 weeks.

The compositions of the present invention can be used as replacements for methyl bromide treatment of agricultural soils. In such embodiments, a bio-derived surfactant and CO2 is applied to the soil of an agricultural area prior to planting. The soil may be saturated with the solution from heavy irrigation, flooding, spraying, drip irrigation (optionally under plastic sheeting), or subsurface injection. Sufficient solution may be applied to treat a specified depth of soil, such as soil from the surface to a depth of any of 6, 12, 18, or 24 inches, or deeper, if desired. Chemigation, the technique of adding chemicals to irrigation water, may be used. Chemigation processes may use, for example, a holding tank for the liquids to be applied, hoses, fittings, couplings, a filter, plus a metering pump such as a Jaeco Fluid Systems (Malvern, Pa.) JaecoAgriPak™ packed plunger chemigation metering injection pump. Any irrigation system type may be used, such as pivot, drip, sub-surface, tape, pipe, laterals sprinkler or open ditch. Users of the invention should note that a sub-surface delivery of the solution results in CO2 evolving less rapidly than in an open air delivery.

Application of the bio-derived surfactant can be in a diluted aqueous solution, or via a concentrated solution (e.g., concentrations of 10% to 100%). When a concentrated solution is applied, it may be subsequently diluted by irrigation, rainwater, etc., such that a more dilute solution is distributed through the soil.

Means of application include spraying such as hand spraying, spraying from a ground or air vehicle (e.g., tractor spraying or aerial spraying, respectively), spraying from spray rigs or blasters, and spraying from spray booms to apply pesticides to trees or other plants, etc. Other application means include flooding (e.g., saturating the soil with a dilute solution such that one or more standing pools form for a period of time over a substantial portion of the ground), irrigation through furrows or other waterways, subsurface injection via buried piping or via temporary insertion of a nozzle or injector into the ground, etc. Application may be directed to specific regions of the soil, such as the soil at the base of a plant, or may be substantially uniformly applied to the soil of an agricultural tract. Examples of known devices and methods for soil treatment with a pesticide or other compounds are disclosed in US 20030159630, “Pesticide Application Tool and Method of Applying Pesticide Below Grade,” by R. R. Rollins, published Aug. 28, 2003, which discusses subterranean application of pesticides. A soil treating tool is proposed having an elongated body portion, a handle portion attached at one end of the body portion and an applicator portion attached to the other end of the body portion. The applicator portion is sized and shaped for insertion under soil and for forming an opening in the soil by lateral movement of the handle portion. The applicator portion defines at least one fluid outlet. A fluid inlet is provided in fluid communication with the applicator portion, such that fluid applied under pressure to the inlet is dispensed from the fluid outlet. A method for the subterranean application of pesticides with the device of Rollins is also described.

U.S. Pat. No. 6,877,272, “Method of Applying Pesticide” by T. Hoshall, issued Apr. 12, 2005, herein incorporated by reference to the extent that it is noncontradictory herewith, describes a method for delivering a pesticide adjacent a foundation of a structure. The method includes injecting the pesticide into a tubular conduit positioned proximate to the foundation of the structure. The pesticide is injected into the tubular conduit at a rate such that the internal pressure of the tubular conduit remains below a threshold pressure of the tubular conduit until the tubular conduit is substantially filled with the pesticide thereby preventing the pesticide from being discharged through pores of the tubular conduit as the tubular conduit is being filled with the pesticide. Continued injection of pesticide into the tubular conduit causes the tubular conduit to be uniformly pressurized above the threshold pressure of the tubular conduit along the length of the tubular conduit to cause the pesticide to be discharged from the tubular conduit at a substantially uniform rate along the length of the tubular conduit and form a chemical barrier against the infestation of pests into the structure through openings formed in the foundation of the structure. The device and method of Hoshall can also be adapted for the present invention, such that installed underground structures can be used to uniformly apply bio-derived surfactants to a specified region, such as a bed of plants, trees, or shrubs at risk to attack by pests.

For soil treatments, any known method of applying insecticides or other agents to soil may be contemplated within the scope of the present invention. Soil may be treated in the field, or pretreated before being delivered to an agricultural site. Soil preparation prior to application of the compounds of the present invention can include tilling-free mechanical treatment of soil, including cutting or slits or formation of holes, trenches, or other structures to allow for liquids or gases to more readily enter the soil.

Soil treatment may also be conducted in conjunction with covering materials such as plastic films over the ground. Film may be applied before or after application of the aqueous compounds of the present invention. For example, in one embodiment, a film may be applied to the soil, and then it may be pushed into the soil at spaced apart regions. The film may be pierced in those regions where it penetrates into the soil, and then the aqueous solution may be applied such that it enters the soil through the pierced covering in the regions where the covering has been pushed into the soil. In one example, a four-centimeter deep hole may be formed in the soil into which a liter or more of the aqueous solution is applied.

With or without films or other ground coverings present, application of the aqueous solution may be done at the base of an existing plant or in the locales where seeds have been or will be planted.

In one embodiment, the same apparatus used to inject methyl bromide into the soil can be used to inject aqueous solutions of the present invention, though the tank may have to be larger and suitable nozzles and control devices may be used for liquid rather than gas. But the principle of injecting the pesticide into the soil and automatically applying a covering material would be used.

When coverings are used, any known ground covering such as Visqueen® polyethylene film (British Polythene Limited, London, England) may be used Plastic films may be clear, black, etc. Other mechanical aids can include soil coverings such as impermeable or vapor permeable film or fabric coverings, layers of materials such as compost or manure, and the like. An example of a film for treatment of the soil is described in U.S. Pat. No. 5,846,661, “Film for the Treatment of Soils by Fumigation,” which may be used after or during treatment with the compounds of the present invention, or may be used for other treatments in combination with the methods of the present invention.

Other known treatments of soil or seeds may be performed in addition to or in combination with the methods of the present invention. Such treatments may be applied prior to, after, or during the implementation of the methods of the present invention. Exemplary other treatments include but are not limited to:
Solarization (e.g., exposure to sunlight under a transparent or translucent plastic film or nonwoven web, for example) and other means for heating soil, such as the method described by R. Gonzalez-Torres, J. M. Meléro-Vara, J. Gámez-Vázquez, and R. M. Jiménez Diaz (1993), “The Effects of Soil Solarization and Soil Fumigation on Fusarium Wilt of Watermelon Grown in Plastic House in South-Eastern Spain,” Plant Pathology 42 (6), pp. 858-864 (doi:10.1111/j. 1365-3059.1993.tb02671.x). In addition, other means of applying energy to the soil can be considered, such as the application of microwaves to cause heating in the soil to attack pests and pathogens. See, for example, U.S. Pat. No. 5,141,059, “Method and Apparatus for Controlling Agricultural Pests in Soil,” issued Aug. 25, 1992 to L. C. Marsh, herein incorporated by reference to the extent that it is noncontradictory herewith. See also G. N. Mavrogianopoulos, A. Frangoudakis and J. Pandelakis (February 2000), “Energy Efficient Soil Disinfestation by Microwaves,” Journal of Agricultural Engineering Research, 75(2): 149-153; as well as U.S. Pat. No. 5,287,818, “Method for Killing Soil Pathogens with Micro-Wave Energy”; and U.S. Pat. No. 6,454,996, “Method for Treating Agricultural Products for Harmful Infestations.”
Gaseous fumigant treatments, including conventional fumigants such as methyl bromide, phosphine and carbonyl sulphide, or mixtures such as the mixed gas of hydrogen phosphide and methyl bromide described in U.S. Pat. No. 5,353,544, “Fumigation Apparatus.” Other fumigant mixtures include the cyanogen treatments described in U.S. Pat. No. 6,001,383, “Cyanogen Fumigants and Methods of Fumigation Using Cyanogen” or US 20070077311, “Fumigant/Sterilant,” which describes cyanogen and carbon dioxide used together as a soil treatment, with the cyanogen concentration below its flammability limit.
Treatments with methyl iodide, sodium metam, dazitol, sodium azide, allyl isothiocyanate, ethylene dibromide, telone or any other known or proposed alternative to methyl bromide.
Composting or application of green manure (adding green plant growth into the soil).

Surfactants increase the soil penetration of carbonated water by 15-85% depending on soil characteristics. Penetration in fine particle clay soils may increase 15% whereas sandy soils may show an increased penetration of 85%. An additional advantage of the use of surfactants is the decrease in water use by the farmer. An 85% increase in soil penetration slows evaporation by approximately 50% due to the increased distance from the soil surface diffusion point.

The increased use of carbon dioxide by plants has the added advantage, in some embodiments, of increasing yields. Elevated levels of CO2 may increase crop yields by up to 25% for some crops.

Methods of use can also include a variety of business models involving the transactions associated with carbon credits or contractual relationship between producers of anthropogenic CO2 and agricultural users. For example, one embodiment comprises a method for facilitating reduction in anthropogenic CO2 emissions by a CO2 producer, comprising the CO2 producer providing a source of carbon dioxide that can be delivered to an agricultural partner, the CO2 producer providing a financial incentive to the agricultural partner to receive the carbon dioxide, the agricultural partner accepting delivery of the carbon dioxide, the agricultural partner applying the carbon dioxide to soil in combination with a surfactant, wherein at least a portion of the applied CO2 is sequestered by at least one of the soil and plant matter growing in the soil, the CO2 producer receiving carbon credits for at least a portion of the CO2 delivered to the agricultural partner, and the agricultural partner receiving the offered incentive. The CO2 producer may generates CO2 from reaction of fossil fuels and then remove a portion of the generated CO2 from flue streams to be delivered to the agricultural partner. Alternatively, the producer may be an energy company that markets fossil fuels which are used by others for energy, and who may receive carbon credits through a relationship with the agricultural partner The relationship may require the agricultural partner to apply carbon dioxide to soil two or more times, such as three or more times per year or per crop rotation.

Another embodiment comprises a method for facilitating reduction in anthropogenic CO2 emissions by a CO2 producer, comprising providing an incentive to the CO2 producer to provide carbon dioxide to an agricultural partner, delivering CO2 from the CO2 producer to the agricultural partner, the agricultural partner applying the carbon dioxide to soil in combination with a surfactant, wherein at least a portion of the applied CO2 is sequestered by at least one of the soil and plant matter growing in the soil, and wherein the application of the carbon dioxide in combination with a surfactant to the soil results in reducing the activity of a pest harmful to a desired plant that is planted in the soil. The incentive may comprise carbon credits that can be traded in a carbon credit market. The CO2 producer may also provide an incentive to the agricultural partner for sequestering at least a portion of the delivered CO2. Again, the producer can be a provider of fossil fuels, an entity that engages in combustion of fossil fuels, or other company or entity with access to carbon dioxide that can be provided for agricultural use to allow the entity to gain the benefit of carbon credits or other incentives to reduce greenhouse gas emissions.

### CO2 Sources

Carbon dioxide can be obtained from any known source for use according to the present invention. For example, membrane separation systems may be used, in addition to cryogenics, adsorption, absorption, etc. CO2 can be stripped from industrial gas streams through contact with a liquid via spraying droplets through the gas streams, contact in any known stripper column design, bubbling the gas through pools of liquid, etc., to create a liquid stream having elevated CO2 The liquid stream may comprise an amine compound such as monoethanolamine or other basic compounds that can capture CO2. The liquid may be an aqueous solution, water alone, or a non-aqueous composition. In amine-based CO2 stripping systems, the absorbed CO2 can typically be driven off by heating the CO2-rich amine in a separate stripper column.

Adsorbents can be used such as zeolites or activated carbon in known CO2 adsorption systems, such as pressure swing adsorption (PSA), temperature swing adsorption (TSA), or electric swing adsorption. An adsorbent that may be useful in some embodiments is the class known as hydrotalcite-like compounds (HTlcs, also known as layered double hydroxides, LDHs) that selectively adsorb CO2 at elevated temperatures and release it simply by changing the pressure. This high temperature CO2 adsorbent can be combined with a heavy reflux PSA cycle for efficient adsorption. A heavy reflux PSA cycle can be used alone or in conjunction with a light reflux process, resulting in a dual reflux cycle.

U.S. Pat. No. 5,520,894, “Process for Removing Carbon Dioxide Regeneratively from Gas Streams,” issued May 28, 1996 to Heesink and Temmink, describes a method of removing CO2 from the flue streams of combustion plants using an adsorbent system. The absorbent used is preferably calcium oxide and/or magnesium oxide, optionally in the presence of calcium carbonate. More preferably, magnesium oxide is used, especially half-calcined dolomite (CaCO3.MgO).

U.S. Pat. No. 6,596,248, “Method for Removing Carbon Dioxide from Exhaust Gas,” issued Jul. 22, 2003 to Schimkat and Baum, describes a CO2 removal system that includes a water/steam cycle.

Japanese Patent Application 51-4090 discloses a process for removing water and CO2 from hot gases, in particular in the manufacture of steel, by treating the gases with CaO and/or MgO. The used oxide can be regenerated, according to this process, by hot air being passed through. In U.S. Pat. No. 3,516,808 a process is described for regenerating calcium oxide which has been used for removing CO2. According to GB-A 2,103,645, CO2 and H2S can be removed in a wet process from gases such as hydrocarbons by treatment with a solution of a tertiary amine and a physical absorbent. Japanese Patent Application 61-146344 discloses a process wherein CO2 and water are removed from inert gases by use of a zeolite bed which is regenerated by heating with combustion gases of a catalyzed combustion of propane.

### EXAMPLES

### Example 1

SoyFast™ Manufacturer's Base marketed by Soy Technologies (Nicholasville, Ky.) was applied to soil in a carbonated aqueous solution to demonstrate the ability to add carbon dioxide with a potentially insecticidal/ herbicidal/nematicidal treatment. A tank of pressurized carbon dioxide was used as the CO2 source. Applied CO2 pressure was controlled with a regulator and flow rates were measured with an electronic flow meter, as shown in FIG. 4. A peristaltic pump delivered the aqueous solution of Manufacturer's Base into a flow line running to a buried horizontal tube of 8-inch diameter Schedule 40 PVC tubing, 3 feet in length, with access caps sealing both ends (see FIGS. 2 and 3). The body of the pipe had spaced apart 1/16-inch holes drilled along the lower surface of the tubing to allow internal fluid to enter the soil. A row of holes spaced 2-inches apart extended along the lower axis of the tubing, with additional rows drilled along both sides of tubing along the horizontal midplane of the tubing, with an additional row between each midplane row and the bottom row. The lower surface of the tubing was buried 18-inches below the surface. After liquid was directed into the tubing to provide a liquid level sufficient to cover the drilled holes, the CO2 was turned on to pressurize the chamber, with CO2 and the liquid solution being combined together as they flowed into a curved-T fitting (a 2-inch diameter “sweep T”), from which the combined flow was directed via a hose into the buried PVC tube, where the liquid and CO2 entered the soil.

The soil above the pipe was enclosed in a sealed wooden chamber, about 4 feet×3 feet in cross section and about 3 feet tall, in which a CO2 monitor was present to monitor CO2 escaping from the earth. In testing, very little CO2 was detected, suggesting that a majority of the applied CO2 may have been retained at least temporarily in the soil.

### Example 2

A gas exchange module containing a gas diffusion membrane was connected to a gas stream containing 10 40% CO2. The gas flow was regulated between 1 and 9 L/min and the backpressure was maintained at 5 PSI. The gas exchange module was simultaneously connected to a water supply which was used to dissolve the CO2. The flow of the water varied from 19 L/min while the pressure was maintained at 10 PSI. At a CO2 concentration of 30%, a gas flow of 7 L/min, and a water flow of 7 L/min, 75% of the mass of carbon dioxide gas from the feed stream was continuously collected into the water. Measurement of the CO2 dissolved in the water indicated that 80 200 ml/L of CO2 was present in the water as dissolved CO2. The 25% of CO2 that was not captured was released as exhaust. The water with the dissolved carbon dioxide was directly applied to turf with added 0.5% surfactant.

### Example 3

In a prophetic embodiment of the invention, carbon dioxide is concentrated in ambient air with a gas concentrator from 0.05 to approximately 0.25%. This concentration can be achieved by the use of zeolite granules, which increase the percentage of carbon dioxide by removing nitrogen from the waste stream. This carbon dioxide enriched gas is used to impregnate a water-surfactant solution being applied to plants and soil. The remaining 25% of total carbon dioxide emission is returned to the atmosphere. Dependent on soil type and plant type, the carbon dioxide applied to soil is reduced by 50-90% resulting in an ultimate reduction from the waste stream of 37.5-67.5%.

The surfactant solution may be 0.01 to 5% dependent on the tolerance of the plant for the solution and the soil type. For example, experience with St. Augustine turf suggests it will withstand a concentration of about 5% of some several bioderived surfactants whereas for tomatoes plant toxicity may be observed less than 3% surfactant must be applied or plant toxicity will result.

### Example 4

Larvae and pupae of the root weevil, Diaprepes abbreviatus, were immersed in a variety of compounds to understand their effect on the activity of this pest. In the tests, the Soy Technologies Manufacturer's Base proved to be effective in rendering the larvae moribund without necessarily killing them. Indeed, the mortality rate for Manufacturer's Base was not greater than the control treatment of tap water or carbonated water.

The criterion for toxicity with these larvae is the lack of nipping behavior and its consequent black residue from blood loss and the lack of spontaneous movement. Compounds and formulations that were toxic nevertheless generated unexpectedly low mortality with time, but rather displayed a moribund effect that appeared to be permanent, which was an unexpected and surprising result. The moribund effect can be likened to the toxicity delivered by a wasp in stinging its prey: the prey lives on but does not feed or move. Pupae also did not move after treatment with the toxic materials identified in this series of test, but were difficult to assess with this design and were not tested further.

Experimental Design. Larvae and pupae were received from the Florida Dept. of Agriculture's rearing program in Gainesville, Fla. Larvae were shipped as 50-day larvae (larvae that will pupate in about 10 days). Both larvae and pupae were held at 27° C. in 12 hour cycles of light and dark in their containers as separate individuals until experimentation began.

Materials for testing were obtained from Sigma-Aldrich. These materials include polyoxyethylene 10 tridecylether (CAS #24938-91-8), ethoxylated castor oil (CAS #61791-12-6, Cremophor, from BASF), dimethylglutarate (CAS #1119-40-0, Fluka, 97% purity), dimethylsuccinate (CAS #106-65-0, Fluka, 98%), dimethyladipate (CAS #727-930 from DuPont), SuperWet 7-057 and Tomadol 1-7 from Anderson Chemical (Litchfield, Minn.), SuperSolve, SC-1000, and SuperCon from GemTek Products (Phoenix, Ariz.), SoyFast Manufacturer's Base from Soy Technologies (Nicholasville, Ky.), and Pel-Soy 676 ethoxylated soybean oil from Pelron Corp. (Lyons, Ill.), a soy ethoxylated soy methyl ester amid (CAS #68425-44-5).

In the testing, five larvae or pupae were removed from their rearing cups and placed in a 150 ml glass beaker. In testing the Soy Technologies Manufacturer's Base (SMTB), a 5% solution was mixed in either water or carbonated water by adding 10 ml of SMTB to a 250 ml beaker and then adding water or carbonated water to the 200 ml mark. The solutions were then immediately added to the beaker with the larvae or pupae to cover them. Controls with water or carbonated water alone were also included. There was a single tray of five larvae for each treatment at each time period and a five larvae control for each time period. Larvae were removed and placed on plastic weighing trays after 5,10, 15, 20, 25, and 30 minutes. At the end of 30 minutes all organisms were assessed for mortality. Trays with larvae were left on the bench tip for 24 hours and then another mortality assessment was made.

Observations. Water controls remained active throughout the 30-minute period and were alive and active when placed in their weighing trays. The larvae treated with 5% Manufacturer's Base were active until about 10 minutes. Larvae became moribund after about 10 minutes. Treated larvae remained inactive for at least one hour after treatment. All treated larvae moved when probed with a sharp probe and were alive at 30 minutes.

Pupae. This insect has a pharate pupa; that is, a pupa that resembles the adult beetle. These pupae move, but they did not move upon probing with a sharp probe and thus proved not useful for this evaluation. There was movement in all trays at 24 hours for the water treatment; there was no movement in the SMTB treatments. For the carbonated water treatment, there was no movement in any Manufacturer's Base treatment at 24 hours. For pupae treated with carbonated water only, there was movement in every tray. The adults in the 5, 10, and 30 minute treatments were alive.

Larvae. At 24 hours the untreated and water controls were active and were nipping at one another. This is a known cannibalistic behavior by the larvae of this species. As a consequence the trays were covered with black blood, the normal color of insect blood when exposed to air. There was movement in all control trays, but not all larvae were moving. The treated larvae were all moribund with no movement in any tray. The untreated controls were all alive at 24 hours.

TABLE 1
Larval mortality 24 hours after from 5% STMB
treatment with time.

Minutes

| | Untreated | 5 | 10 | 15 | 20 | 25 | 30 |
|---|---|---|---|---|---|---|---|
| Water | 0 | 0 | 2 | 0 | 0 | 0 | 0 |
| STMB | 0 | 0 | 0 | 0 | 0 | 0 | 0 |

STMB = Soy Tech Manufacturers Base

Cannibalistic behavior leads to dirty larvae and a black residue. This indicates healthy larvae. Lack of a black residue and clean larvae signal moribund and sick larvae. The untreated and water controls were discarded as these larvae were in no condition for an assessment for an additional 24 hours. The treated larvae were left on the bench top for an additional 24 hours. The results for Manufacturer's Base in carbonated water were the same as for SMTB in water. Treated larvae were moribund and clean except for the untreated control. Carbonated water controls were dirty with a black residue in each tray, i.e., healthy with normal behavior. After 48 hours these larvae were generally alive (Table 2) and moribund.

TABLE 2
Mortality of larvae with 5% STMB in
carbonated water with time.

| | | Minutes | | | | | |
|---|---|---|---|---|---|---|---|
| | Untreated | 5 | 10 | 15 | 20 | 25 | 30 |
| 24 hours | 3 | 1 | 0 | 1 | 0 | 1 | 1 |
| Carbonated water | | | | | | | |
| STMB in | 3 | 0 | 1 | 2 | 0 | 1 | 0 |
| Carbonated Water | | | | | | | |
| 48 hours* | — | 1 | 2 | 2 | 1 | 2 | 1 |

*Carbonated water controls discarded after 24 hours.

Concentration Series. With the results from the time series above, larvae were held in different concentrations of STMB for 30 minutes. After 30 minutes, solutions were poured off and the trays wiped dry. Assessments were made at 24 or 48 hours with a few assessments at 72 hours dependent on effects. Treatments were: water or carbonated water as controls, and 0.1, 0.5, 1.0, 2.0, 3.0, 4.0 and 5.0% concentrations in either distilled water or carbonated water. Five larvae were used for each control and treatment. Pupae were not used in this assessment.

TABLE 3
Mortality with STMB and concentration.

| Time | | % Concentrations | | | | | | |
|---|---|---|---|---|---|---|---|---|
| period | Untreated | 0.1 | 0.5 | 1.0 | 2.0 | 3.0 | 4.0 | 5.0 |
| 24 hours | 0 | 2 | 0 | 2 | 0 | 0 | 1 | 1 |
| 48 hours | 3 | 2 | 1 | 2 | 3 | 0 | 3 | 2 |
| 72 hours | 4 | 3 | 2 | 2 | 5 | 2 | 4 | 5 |
| 96 hours | 4 | 3 | 2 | 3 | 5 | 2 | 4 | 5 |

Results are shown in Table 3 above. At 48 hours 0.1 ml of water was added to each tray to prevent desiccation. At 48 hours the water controls were in very poor shape due to nipping. The 0.1% treatment looked about like the water controls at 48 hours. Overall, for treatments 0.5% and up the larvae died from the treatment. The water and 0.1% treatments died from blood loss as evidenced by the black residue in those trays.

The use of carbonated water appeared not to increase the efficacy of this treatment. After 48 hours, there appeared to be no difference between 5% STMB in water and 5% STMB in carbonated water. Based on these data, only larvae were used and the assessment of compounds was made with water or carbonated water controls, 0.1, 1.0, 0.3, and 5.0% concentrations. In general, 48 hours should be enough for this assessment. Lack of toxicity or high toxicity should show in the first 24 hours.

For compounds that mimic STMB with clean and moribund larvae, this assessment will be extended to 72 hours.

Other Compounds: Ethoxylated castor oil (CAS #61791-12-6). After 24 hours, the control and 0.1% treatment looked the same. 1.0 and 3.0% treatments have less blood residue than the control and 0.1%. The 5.0% treatment larvae were moribund. At 48 hours, it is obvious that the dead were from nipping. The 5.0% treatment resulted in larvae that were clean, moribund and obviously sick. The 5.0% larvae were set together in a covered cup, to assess for mortality. The other treatments were discarded at 48 hours. At 72 hours, there was still only one dead, all larvae were clean and moribund.

Dimethyladipate (a.k.a. Adipic Acid, Dimethyl Ester or Dimethyl hexanedioate, CAS #727-930). Preparations of 1.0, 3.0, and 5.0% concentration were not completely soluble. The solutions were poured off the top for treatment. The 0.1% preparation was soluble. The 3 and 5% solutions attacked the plastic. This is a rather noxious compound and not recommended for use. At 24 hours the control and 0.1% looked identical and not much different from the 1.0 and 3.0% treatments The 5.0% treatment contained only slightly less black residue than the 3.0% treatment. This compound was judged non-toxic to specimens and the test was terminated at 24 hours.

Results for the tested compounds, showing CAS numbers when available, are presented in Table 4.

TABLE 4
Mortality of larvae with individual compounds
and formulations.

| | | Concentration percent | | | | |
|---|---|---|---|---|---|---|
| Compound | Time | Control | 0.1 | 1.0 | 3.0 | 5.0 |
| 61791-12-6 | 24 hours | 0 | 0 | 1 | 2 | 1 |
| | 48 hours | 0 | 0 | 3 | 3 | 1 |
| | 72 hours | — | — | — | — | — |
| Pel-Soy 676 | 24 hours | 1 | 2 | 0 | 1 | 0 |
| | 48 hours | 2 | 3 | 1 | 1 | 0 |
| | 72 hours | 3 | 3 | 1 | 3 | 0 |
| | 120 hours | 5 | 5 | 3 | 3 | 1 |
| 106-65-0 | 24 hours | 0 | 2 | 2 | 1 | 1 |
| 627-93-0 | 24 hours | 1 | 2 | 1 | 2 | 3 |
| 24938-91-8 | 24 hours | 0 | 0 | 2 | 0 | 0 |
| | 48 hours | 0 | 0 | 2 | 0 | 3 |
| | 72 hours | 0 | 0 | 2 | 0 | 3 |
| SC-1000 | 24 hours | 0 | 0 | 2 | 0 | 0 |
| Tomadol 1-7 | 48 hours | 1 | 0 | 0 | 1 | 2 |
| | 72 hours | 2 | 0 | 1 | 2 | 1 |
| 1119-40-0 | 48 hours | 2 | 3 | 1 | 0 | 1 |
| | 72 hours | 4 | 3 | 2 | 0 | 2 |
| Supersolve | 48 hours | 1 | 1 | 2 | 3 | 2 |
| | 72 hours | 1 | 2 | 5 | 3 | 2 |

After 30 minutes, all larvae were alive in all tests.

Polyoxyethylene 10 tridecylether (a.k.a._polyoxyethylene tridecyl alcohol, tridecyl alcohol ethoxylate, with structure C13H27(OCH2CH2)nOH, CAS #24938-91-8). At 24 hours there was a gradation of black residue from control to 5.0 with 5.0 having the least. At 48 hours all treatments had black residue. The control, 0.1 and 1.0% were the same with 3 and 5 having less black residue and equal to one another.

SC-1000. At 24 hours all trays appeared equal in black residue. Larvae were active. This formulation is judged to be non-toxic to these larvae. This test was terminated at 24 hours.

Pel-Soy 676. The 3.0 and 5.0% treatments were fairly viscous solutions. The 1.0 and 0.1% solutions mixed easily. The 3 and 5% solutions are syrupy. At 24 hours the 3.0 and 5.0% treatments were moribund with clean trays. The control had presented the blackest residue, then 0.1, then 1.0. At 48 hours 3.0 and 5.0 were fairly clean. The control and 0.1 look the same with 1.0 in between. At 96 hours there was a gradation of black residue from control to 5.0 with 5.0 being the least. The toxicity in 1.0, 3.0, and 5.0% treatments resemble STMB toxicity.

Dimethyl succinate (a.k.a._butanedioic acid, dimethyl ester CAS #106-65-0). The 3% and 5% concentrations were not soluble while the 1.0% appears to be just soluble. The 0.1% was soluble. This treatment was terminated after 24 hours as all treatments looked just like the control. This compound was judged to be non-toxic to these larvae.

Tomadol 1-7 (an alcohol ethoxylate made from linear C11 alcohol with 7 moles average of ethylene oxide and an HLB of 12.9) All larvae were alive after 30 minutes. The 5% solution is on the cusp of solubility. At 48 hours the 1, 3, and 5% treatments had less black residue compared to the control and 0.1%.

Dimethylglutarate (a.k.a._pentanedioic acid, dimethyl ester, CAS #1119-40-0). All larvae were alive after 30 minutes. The 1, 3, and 5% solutions were not completely soluble. At 48 hours the 3 and 5% treatments have less black residue than the control and 0.1 and 1.0% which appear to be equal in black residue.

Supersolve (from GemTek Products, Phoenix, Ariz., believed to contain bio-derived surfactants obtained from fatty acids). All treated larvae were alive and moribund at 30 minutes. The water controls were alive and active after 30 minutes. The 3 and 5% solutions were cloudy and yellow. The 3 and 5% treatment larvae defecated, the first time this happened in these tests. At 48 hours there was less black residue in the 3 and 5% treatments. The control, 0.1, and 1.0% treatments appeared to have equal amounts of black residue.

### Example 5

Nematicidal properties of a compound within the scope of the present invention were explored with the assistance of Radewald Research & Diagnostics (Moreno Valley, Calif.). One hundred pots were each filled with 500 grams of soil that was infested with root knot nematodes. The pots were apportioned among ten different test series. In each test series, nine pots were drenched with 150 ml of SoyFast™ Manufacturer's Base marketed by Soy Technologies (Nicholasville, Ky.) with concentrations that ranged from 0.1% to 10% and a tenth pot was drenched with 150 ml of tap water alone. The drench volume was adequate to saturate the pot and result in some runoff.

For each level of treatment, five pots were sampled for nematodes 72 hours after treatment, and five additional pots were samples 120 hours after treatment. Results are shown in Table 5 below, with numbers indicating the actual number of root knot nematodes counted per 500 gm of soil. Each 500 gm portion of root knot infested soil was processed via the wet screen Baerman technique.

TABLE 5
Treatments for Root Knot Nematodes

| | | | | 3 days + |
|---|---|---|---|---|
| Treatment | Concentration | 3 days | 5 days | 5 days |
| 1 | 0.1% | 2540 | 2860 | 5400 |
| 2 | 0.5% | 1820 | 2490 | 4310 |
| 3 | 1% | 1900 | 1710 | 3610 |
| 4 | 2% | 912 | 1392 | 2304 |
| 5 | 3% | 300 | 356 | 656 |
| 6 | 4% | 232 | 712 | 944 |
| 7 | 5% | 160 | 368 | 528 |
| 8 | 7.5% | 82 | 286 | 368 |
| 9 | 10% | 122 | 76 | 198 |
| 10 | 0% | 2120 | 1430 | 3550 |

The results show significant decreases in nematode populations for concentrations of about 2% and higher.

### Example 6

To test the effectiveness of a bio-derived surfactant against citrus nematodes, citrus nematode (Tylenchulus semipenetrans) infested soil was taken from a citrus field, well mixed and screened for large debris and potted in 500 ml plastic containers with drainage holes. The infested soil was near field capacity, loamy sand with a stable organic content of about 1.0% . Air temperature of between 75-82° F. was maintained for this trial. One hundred pots were filled with the infested soil. Ten were drenched with 100 ml of each of the nine (9) concentrations of the SoyFast™ Manufacturer's Base marketed by Soy Technologies (Nicholasville, Ky.) with concentrations that ranged from 0.1% to 10%, and a tenth pot was drenched with 100 ml of tap water alone. The 100 ml drench per pot was adequate to saturate the soil and provide some runoff.

Five pots of all treatments were sampled for nematodes 72 hours after treatment and five after 120 hours. Results are presented in Table 6. Numbers in the tables represent the actual number of citrus nematodes per 50 ml of soil. The soil (50 ml) was taken randomly from each pot after mixing the pot contents (500 ml) and processed with the soil Baerman technique. Samples were on the funnels for processing for 72 hours.

TABLE 6
Treatments for Citrus Nematodes

| | | | | 3 days + |
|---|---|---|---|---|
| Treatment | Concentration | 3 days | 5 days | 5 days |
| 1 | 0.1% | 2650 | 2205 | 4855 |
| 2 | 0.5% | 1750 | 1020 | 2770 |
| 3 | 1% | 294 | 736 | 1030 |
| 4 | 2% | 144 | 268 | 412 |
| 5 | 3% | 6 | 26 | 32 |
| 6 | 4% | 0 | 5 | 5 |
| 7 | 5% | 0 | 14 | 14 |
| 8 | 7.5% | 1 | 0 | 1 |
| 9 | 10% | 0 | 1 | 1 |
| 10 | 0% | 2320 | 2352 | 4672 |

The results show significant decreases in nematode populations for concentrations of about 1% and higher.

### Example 7

SC-1000, a product of GemTek Products (Phoenix, Ariz.) comprising bio-derived surfactants, was applied in an aqueous solution via an irrigation system to the grass on a lawn, with the observation that the regions treated grew better than untreated regions. The observations suggest that not only is the composition not harmful to the grass, but stimulated growth. Without wishing to be bound by theory, it is believed that the improved penetration of the surfactant solution into the soil, due at least in part to decreased surface tension, allowed water to be better retained in the soil and used by the plant.

### Example 8

The impact of the bio-derived surfactant on solution penetration into the soil was explored by visual examination of wetting experiments conducted for a Florida sandy soil (Candler Fine Sand) between two parallel glass plates. Experiments were designed to determine if there is a difference between the infiltration of carbonated, non-carbonated water, carbonated surfactant solutions and non-carbonated surfactant solutions in Candler Fine Sand. The control treatments are water and carbonated water. The experimental treatments are 1, 3, and 5% surfactant solutions of Soytech Manufacturers' Base, SC-1000 and Super Wet (Anderson Chemicals). In tests of liquid penetration into the sand, followed by examination of the wetted cross-sections of soil, it was observed that control treatments usually result in a broad wetted area at the top of the soil column (at the air interface) that becomes more narrow with depth. But the presence of surfactant and/or carbonation resulted in a profile that became wider with depth.

While water poured onto a region of the soil showed a wetting profile that resembled the letter “V”-wide at the upper surface and narrower in cross-section away from the surface, the solution with about 3% bio-derived surfactant (SC-1000 of GemTek Products) showed the opposite trend: the wetted region tended to grow laterally as the fluid moved downward, resulting in a wetted cross-sectional profile more like a trapezoid with a broad base and narrow top, rather than like the “V” seen with plain tap water. Without wishing to be bound by theory, it is believed that the reduced surface tension in the bio-derived surfactant solution allows water to penetrate into the air-filled and sometimes hydrophobic pores of the soil more readily and produces enhanced lateral wicking. Whatever the cause of the observed behavior, the ability of the bio-derived surfactant solutions of the present invention to spread laterally suggests that application at the top of a plant by pouring or otherwise applying the solution may be sufficient to reach much of the soil in contact with the roots, especially in cases where the roots are broad in lateral scope. The implication is that the application of an aqueous solution applied at a single spot at the base of a plant is more likely to spread out laterally lower in the soil and thus more likely to treat a root ball or laterally spread roots when the surfactant is present, or when carbonation is present, or both.

### Example 9

pH effects were explored with SC-1000. When diluted in a 1:3 ratio with water, a solution of SC-1000 had a pH of about 11. The same solution, when exposed to pressurized carbon dioxide to become slightly carbonated, had a pH of about 9. Neutralization of the pH of alkaline bio-derived surfactants with carbon dioxide is within the scope of the present invention and may be used for suitable applications.

### Example 10

Tests with SC-1000 were conducted to examine the effect on germination of morning glory seeds, a troublesome weed in many parts of the United States. In a greenhouse test, 400 seeds were planted, with 100 for each of four trials. Trials conducted included treatment with SC-1000 (GemTek), Manufacturer's Base by Soy Technologies, SuperWet (Anderson Chemical), and tap water as the control. Candler Fine Sand was used, which is a well-known soil in Florida with about 1% organic matter. Testing involved drenching with solutions of various concentrations of the applied compounds: 5%, 4, 3, 2, and 1%. For each applied concentration, the number of plants that germinated was counted, with counts conducted weekly for three weeks. The tests showed that concentrations above 1% were effective in stopping or substantially delaying germination of the morning glory seeds.

A related test was conducted with tomato and pepper seeds in the same tray where the weed seeds were. The results showed that weed germination was prevented for applied concentrations above 1%, whereas the tomatoes and peppers could still germinate, though germination may have been delayed.

### Example 11

Phytotoxicity was explored by applying SC-1000 at various concentrations to living plants in a drench applied at the base of the plant, In general, it has been observed that at high concentrations such as at 5% or higher, plants are damaged or killed, whereas little harm is seem for lower concentrations. For concentrations that do not appear to injure the plant right away, an examination of plant height change over a 3 week period showed no difference in plant growth relative to the controls.

The relatively low phytoxicity of SC-1000 and its effectiveness in hindering weed germination and growth suggests that bio-derived surfactants may be useful in controlling weeds without damaging the crops themselves. This is an important observation because it suggests that in addition or instead of soil treatment prior to planting, the compounds of the present invention may be applied directly to post-emergent crops in the areas where pests are a problem. The ability to spot-treat crops as pests emerge may allow for much more efficient use of pesticides (application only where needed, resulting in lower costs, less waste and reduced environmental impact).

Spot treatment of existing crops cannot be done with methyl bromide or with most proposed replacements because the plant would be killed or injured. Thus spot treatments during the growing season are generally not feasible with conventional soil pesticides. For example, when a citrus grove or grape vineyard is infected with root weevil (diaprepes), spot treatment with methyl bromide is not possible without harming the plant.

### Example 12

An experiment with bell peppers on Florida farm land demonstrated improved yields using a bio-derived pesticidal treatment. Aqueous solutions comprising 5% SC-1000 (GemTek Products, Phoenix, Ariz.) were applied preplant from a Ag Sprayer (water wagon) at a rate of approximately 15 gallons of liquor per acre. Approximately 2 acres were treated 2 weeks prior to plant under plastic similar to typical procedures using Methyl Bromide 6733. Another 2 acres was applied immediately prior to plastic application and planting. Another 1 acre had the solution topically applied to the soil through soaker hoses at the base of the plants after they were placed in the soil without the application of plastic. Observations suggested that the treated soiled and treated plants allowed the peppers to thrive, with no evidence of phytotoxicity.

Throughout the growing process, plants were monitored weekly, and in general appeared to be grow taller and more densely than the plants in soil that had been treated with methyl bromide. The final yield of the plants grown in soil treated with SC-1000 was estimated to be about 20% greater than those raised in soil treated with methyl bromide.

### Example 13

The SC-1000 product of GemTek Products (Phoenix, Ariz.) was used to treat lime seedlings in a greenhouse environment to examine harm to the plants. Plants were irrigated with aqueous dilutions of the mixture, up to a concentration of 5% SC-1000. Observations of the seedlings up to 14 days after exposure indicated no detectable harm. Thus, it appears that the bio-derived surfactant composition may be able to be used directly on some young plants without obvious harm.

### Remarks

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above compositions, products, and methods without departing from the scope of aspects of the invention, it is intended that all matter contained in the above description shall be interpreted as illustrative and not in a limiting sense.

While the foregoing description makes reference to particular illustrative embodiments, these examples should not be construed as limitations. The inventive system, methods, and devices can be adapted for many other uses not explicitly listed above, and can be modified in numerous ways within the spirit of the present disclosure. Thus, the present invention is not limited to the disclosed embodiments, but is to be accorded the widest scope consistent with the claims below.

We claim:

1. A method of reducing the harmful impact on a desired plant of one or more harmful nematode or insect species in soil comprising:
applying an elevated concentration of carbon dioxide in the presence of a bio-derived surfactant, wherein an effective amount of carbon dioxide is delivered to the soil to promote at least one of reducing the activity of the harmful nematode or insect species, killing the harmful nematode or insect species, and stimulating growth of the desired plant.

2. The method of claim 1, wherein the the surfactant is derived by esterification of lipid having a carbon number of 16 or higher, said surfactant having an HLB value greater than about 6.

3. The method of claim 1, wherein the bio-derived surfactant prior to application to the soil is in an aqueous solution exposed to carbon dioxide at a partial pressure of at least 1 psi to provide an elevated concentration of carbon dioxide or reaction products of carbon dioxide in the solution when it is applied to the soil.

4. The method of claim 1, wherein the surfactant is present in a carbonated aqueous solution.

5. The method of claim 1, further comprising combining the surfactant with carbonated water.

6. The method of claim 1, wherein delivery of an effective amount of carbon dioxide comprises sub-surface injection of carbon dioxide gas into the soil.

7. The method of claim 6, wherein the surfactant is applied to the soil prior to application of the elevated concentration of carbon dioxide.

8. The method of claim 6, wherein the surfactant is applied to the soil after application of the elevated concentration of carbon dioxide.

9. The method of claim 6, wherein the surfactant is applied to the soil substantially during application of the elevated concentration of carbon dioxide.

10. The method of claim 1, wherein the application of carbon dioxide is selected from irrigation with carbonated water, sub-surface injection of carbon dioxide gas, and application of carbon dioxide to the surface of the soil.

11. The method of claim 1, wherein the surfactant comprises at least one of a methoxylated vegetable oil and an ethoxylated vegetable oil, the ethoxylated vegetable oil having an HLB value greater than about 5, and wherein the concentration of the surfactant in the aqueous solution is at least 0.1%.

12. The method of claim 1, wherein the surfactant comprises an ethoxylate of soybean oil or castor oil.

13. The method of claim 1, wherein reducing the harmful impact on a desired plant of one or more harmful nematode or insect species in soil is obtained without application of an effective amount of a chemical pesticide.

14. The method of claim 1, wherein the surfactant is applied in an aqueous solution that is substantially free of all chemical pesticides registered with the EPA as of Jul. 30, 2007, and wherein the aqueous solution is effective in substantially reducing the activity or population of one of a harmful nematode or harmful insect species in the soil without the use of additional pesticidal agents.

15. The method of claim 1, wherein the soil immediately after application of the carbon dioxide and surfactant is substantially free of effective amounts of EPA-registered pesticides other than minimal risk pesticides, based on registration as of Jul. 30, 2007.

16. The method of claim 1, wherein the treatment with the surfactant and the carbonx dioxide produces two or more functions that effectively reduce the damage to a crop from at least two differing types of pests, the functions being selected from reducing the activity of insect larvae, reducing the activity of nematodes, and harming weeds by at least one of preventing germination, stunting the growth of existing weeds, or killing weeds.

17. The method of claim 1, wherein application of the surfactant comprises at least one of spraying, injection into the soil, drip irrigation, and flooding.

18. The method of claim 1, wherein application of the surfactant is done prior to planting an intended crop.

19. The method of claim 1, wherein the surfactant is provided in an aqueous solution having a concentration from about 0.1% to about 5%, further comprising delivering elevated concentrations of carbon dioxide into the soil as the aqueous solution is applied.

20. The method of claim 1, further comprising contacting the aqueous solution with an atmosphere of pressurized carbon dioxide prior to application of the aqueous solution to the soil sufficiently long to substantially elevate the levels of dissolved carbon dioxide in the aqueous solution.

21. The method of claim 20, further comprising injecting the aqueous solution with elevated levels of dissolved carbon dioxide into the soil from a buried injection unit.

22. A method for facilitating reduction in CO2 emissions by a CO2 producer, comprising the CO2 producer providing a source of carbon dioxide that can be delivered to an agricultural partner, the CO2 producer providing a financial incentive to the agricultural partner to receive the carbon dioxide, the agricultural partner accepting delivery of the carbon dioxide, the agricultural partner applying the carbon dioxide to soil in combination with a surfactant, wherein at least a portion of the applied CO2 is sequestered by at least one of the soil and plant matter growing in the soil, the CO2 producer receiving carbon credits for at least a portion of the CO2 delivered to the agricultural partner, and the agricultural partner receiving the offered incentive.

23. The method of claim 22, wherein the CO2 producer generates CO2 from reaction of fossil fuels and removes a portion of the generated CO2 from flue streams to be delivered to the agricultural partner.

24. The method of claim 22, wherein the CO2 producer markets fossil fuels which are used by others for energy.

25. The method of claim 22, wherein the agricultural partner and the CO2 producer are in a contractual relationship requiring the agricultural partner to apply carbon dioxide to soil two or more times.

26. A method for facilitating reduction in CO2 emissions by a CO2 producer, comprising providing an incentive to the CO2 producer to provide carbon dioxide to an agricultural partner, delivering CO2 from the CO2 producer to the agricultural partner, the agricultural partner applying the carbon dioxide to soil in combination with a surfactant, wherein at least a portion of the applied CO2 is sequestered by at least one of the soil and plant matter growing in the soil, and wherein the application of the carbon dioxide in combination with a surfactant to the soil results in reducing the activity of a pest harmful to a desired plant that is planted in the soil.

27. The method of claim 26, wherein the incentive comprises carbon credits that can be traded in a carbon credit market.

28. The method of claim 27, further comprising the CO2 producer providing an incentive to the agricultural partner for sequestering at least a portion of the delivered CO2.

29. The method of claim 26, wherein the CO2 producer generates CO2 from reaction of fossil fuels and removes a portion of the generated CO2 from flue streams to be delivered to the agricultural partner.

30. The method of claim 26, wherein the CO2 producer markets fossil fuels which are used by others for energy.
